(19) United States
(12) Patent Application Publication
(10) Pub. No.: US 2026/0086434 A1
(43) Pub. Date: Mar. 26, 2026

(54) IMAGING LENS DRIVING MODULE, CAMERA MODULE AND ELECTRONIC DEVICE

(71) Applicant: LARGAN DIGITAL CO., LTD., Taichung City (TW)

(72) Inventors: Heng-Yi SU, Taichung City (TW); Yi Hua TSENG, Taichung City (TW); Te-Sheng TSENG, Taichung City (TW)

(21) Appl. No.: 19/331,023

(22) Filed: Sep. 17, 2025

Related U.S. Application Data
(60) Provisional application No. 63/698,631, filed on Sep. 25, 2024.

(51) Int. Cl. G03B 13/36; G02B 27/64; G03B 5/02; G03B 30/00

(52) U.S. Cl. CPC G03B 13/36; G03B 30/00; G02B 27/646; G03B 5/02; G03B 2205/0015; G03B 2205/0069

(57) ABSTRACT

An imaging lens driving module includes an imaging lens assembly, a lens carrier, a frame element, a ball set, a wiring substrate, a resilience wiring sheet and a driving unit. The lens carrier is configured to install the imaging lens assembly, the frame element is disposed corresponding to the lens carrier, the ball set is disposed between the lens carrier and the frame element, the wiring substrate is disposed on an image side of the imaging lens assembly, and the resilience wiring sheet is configured to connect the lens carrier and the wiring substrate. The resilience wiring sheet includes a movable end, a fixed end, a connecting portion, an elastic portion and a principal constraint component. The elastic portion includes at least two meandering branches and a node. The driving unit includes a first coil, a second coil and a first magnetic element.

### RELATED APPLICATIONS

This application claims priority to U.S. Provisional Application Ser. No. 63/698,631, filed Sep. 25, 2024, which is herein incorporated by reference.

### BACKGROUND

### Technical Field

The present disclosure relates to an imaging lens driving module and a camera module. More particularly, the present disclosure relates to an imaging lens driving module and a camera module applicable to portable electronic devices.

### Description of Related Art

In the recent years, portable electronic devices have developed rapidly. For example, intelligent electronic devices and tablets have been filled in the lives of modern people, and imaging lens driving modules mounted on portable electronic devices and mobile transportations have also prospered. However, as technology advances, the quality requirements of imaging lens driving modules are becoming higher and higher. Therefore, an imaging lens driving module, which is beneficial for improving the structural strength, needs to be developed.

### SUMMARY

According to one aspect of the present disclosure, an imaging lens driving module includes an imaging lens assembly, a lens carrier, a frame element, a ball set, a wiring substrate, a resilience wiring sheet and a driving unit. The imaging lens assembly has an optical axis, the lens carrier is configured to install the imaging lens assembly, and the frame element is disposed corresponding to the lens carrier. The ball set is disposed between the lens carrier and the frame element, wherein the ball set is physically contacted with the lens carrier and the frame element. The wiring substrate is disposed on an image side of the imaging lens assembly, the resilience wiring sheet is configured to connect the lens carrier and the wiring substrate, and the resilience wiring sheet includes a movable end, a fixed end, a connecting portion, an elastic portion and a principal constraint component. The movable end is coupled and fixed with the lens carrier without a movement relative to the lens carrier, the fixed end is coupled and fixed with the wiring substrate without a movement relative to the wiring substrate, and the connecting portion is connected to the movable end. The elastic portion connects the fixed end and the connecting portion, the elastic portion extends in a direction parallel to the optical axis, and the elastic portion includes at least two meandering branches and a node. The at least two meandering branches extend in a direction towards the fixed end, the at least two meandering branches overlap each other in a specific direction in view, and the at least two meandering branches extend in the direction towards the fixed end and converge at the node. The principal constraint component is coupled with the connecting portion and the elastic portion so that a first angle is formed between the connecting portion and the elastic portion. The driving unit is configured to drive the lens carrier to move relative to the wiring substrate in a direction parallel to the optical axis or in a direction perpendicular to the optical axis, and the driving unit includes a first coil, a second coil and a first magnetic element. The first coil is disposed at the movable end of the resilience wiring sheet, the second coil is disposed on a surface of the wiring substrate, the first magnetic element is disposed on an assembling portion of the frame element, and the first magnetic element faces and is disposed corresponding to both the first coil and the second coil. When a straight length of the elastic portion in a direction along the optical axis is D, and a total length of the at least two meandering branches is L, the following conditions are satisfied: D<L, and 1.4<L/D<17.

According to one aspect of the present disclosure, an imaging lens driving module includes an imaging lens assembly, a lens carrier, a frame element, a ball set, a wiring substrate, a resilience wiring sheet and a driving unit. The imaging lens assembly has an optical axis, the lens carrier is configured to install the imaging lens assembly, and the frame element is disposed corresponding to the lens carrier. The ball set is disposed between the lens carrier and the frame element, wherein the ball set is physically contacted with the lens carrier and the frame element. The wiring substrate is disposed on an image side of the imaging lens assembly, the resilience wiring sheet is configured to connect the lens carrier and the wiring substrate, and the resilience wiring sheet includes a movable end, a fixed end, a connecting portion and an elastic portion. The movable end is coupled and fixed with the lens carrier without a movement relative to the lens carrier, the fixed end is coupled and fixed with the wiring substrate without a movement relative to the wiring substrate, and the connecting portion is connected to the movable end. The elastic portion connects the fixed end and the connecting portion, the elastic portion extends in a direction parallel to the optical axis, and the elastic portion includes at least two meandering branches. The at least two meandering branches extend in a direction towards the fixed end, and the at least two meandering branches overlap each other in a specific direction in view. The driving unit is configured to drive the lens carrier to move relative to the wiring substrate in a direction parallel to the optical axis or in a direction perpendicular to the optical axis, and the driving unit includes a first coil, a second coil and a first magnetic element. The first coil is disposed at the movable end of the resilience wiring sheet, the second coil is disposed on a surface of the wiring substrate, the first magnetic element is disposed on an assembling portion of the frame element, and the first magnetic element faces and is disposed corresponding to both the first coil and the second coil. When a maximum width of the elastic portion closed to the connecting portion is Wc, and a minimum width of each of the at least two meandering branches closed to the fixed end is Wf, the following conditions are satisfied: Wf<Wc; and 1.5<Wc/Wf<16.

According to one aspect of the present disclosure, an imaging lens driving module includes an imaging lens assembly, a lens carrier, a frame element, a ball set, a wiring substrate, a resilience wiring sheet and a driving unit. The imaging lens assembly has an optical axis, the lens carrier is configured to install the imaging lens assembly, and the frame element is disposed corresponding to the lens carrier. The ball set is disposed between the lens carrier and the frame element, wherein the ball set is physically contacted with the lens carrier and the frame element. The wiring substrate is disposed on an image side of the imaging lens assembly, the resilience wiring sheet is configured to connect the lens carrier and the wiring substrate, and the resilience wiring sheet includes a movable end, a fixed end, a connecting portion and an elastic portion. The movable end is coupled and fixed with the lens carrier without a movement relative to the lens carrier, the fixed end coupled and fixed with the wiring substrate without a movement relative to the wiring substrate, and the connecting portion is connected to the movable end. The elastic portion connects the fixed end and the connecting portion, the elastic portion extends in a direction parallel to the optical axis, and the elastic portion includes at least two meandering branches and a node. The at least two meandering branches extend in a direction towards the fixed end, the at least two meandering branches overlap each other in a specific direction in view, and the at least two meandering branches extend in the direction towards the fixed end and converge at the node. The driving unit is configured to drive the lens carrier to move relative to the wiring substrate in a direction parallel to the optical axis, and the driving unit includes a first coil and a first magnetic element. The first coil is disposed at the movable end of the resilience wiring sheet, the first magnetic element is disposed on an assembling portion of the frame element, and the first magnetic element faces and is disposed corresponding to the first coil. When a shortest distance between the fixed end and the node in a direction parallel to the optical axis is Hn, and a straight length of the elastic portion in a direction along the optical axis is D, the following conditions are satisfied: Hn<D; and 0.1≤Hn/D≤0.7.

According to one aspect of the present disclosure, a camera module includes the imaging lens driving module of the aforementioned aspect and an image sensor corresponding to an image surface of the imaging lens assembly of the imaging lens driving module.

According to one aspect of the present disclosure, an electronic device includes the camera module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of a camera module according to the 1st Example of the 1st Embodiment of the present disclosure.

FIG. 1B is a partial enlarged view of the camera module according to the 1st Example of the 1st Embodiment in FIG. 1A.

FIG. 1C is a top view of the camera module according to the 1st Example of the 1st Embodiment in FIG. 1A.

FIG. 1D is a cross-sectional view of the 1st Example of the 1st Embodiment along a cross line 1D-1D in FIG. 1C.

FIG. 1E is an exploded view of the camera module according to the 1st Example of the 1st Embodiment in FIG. 1A.

FIG. 1F is another exploded view of the camera module according to the 1st Example of the 1st Embodiment in FIG. 1A.

FIG. 1G is another exploded view of the camera module according to the 1st Example of the 1st Embodiment in FIG. 1A.

FIG. 1H is a three-dimensional view of the resilience wiring sheet according to the 1st Example of the 1st Embodiment in FIG. 1A.

FIG. 1I is a side view of the resilience wiring sheet according to the 1st Example of the 1st Embodiment in FIG. 1H.

FIG. 1J is a top view of the resilience wiring sheet according to the 1st Example of the 1st Embodiment in FIG. 1H.

FIG. 1K is a parameter schematic view of the resilience wiring sheet according to the 1st Example of the 1st Embodiment in FIG. 1A.

FIG. 1L is a partial enlarged view of the resilience wiring sheet according to the 1st Example of the 1st Embodiment in FIG. 1K.

FIG. 1M is a three-dimensional view of a resilience wiring sheet according to the 2nd Example of the 1st Embodiment in FIG. 1A.

FIG. 1N is a side view of the resilience wiring sheet according to the 2nd Example of the 1st Embodiment in FIG. 1M.

FIG. 1O is a top view of the resilience wiring sheet according to the 2nd Example of the 1st Embodiment in FIG. 1M.

FIG. 1P is a schematic view of an elastic portion according to the 2nd Example of the 1st Embodiment in FIG. 1M.

FIG. 2A is a three-dimensional view of a camera module according to the 1st Example of the 2nd Embodiment of the present disclosure.

FIG. 2B is a top view of the camera module according to the 1st Example of the 2nd Embodiment in FIG. 2A.

FIG. 2O is a cross-sectional view of the camera module along a cross line 2C-2C according to the 1st Example of the 2nd Embodiment in FIG. 2B.

FIG. 2D is an exploded view of the camera module according to the 1st Example of the 2nd Embodiment in FIG. 2A.

FIG. 2E is another exploded view of the camera module according to the 1st Example of the 2nd Embodiment in FIG. 2A.

FIG. 2F is another exploded view of the camera module according to the 1st Example of the 2nd Embodiment in FIG. 2A.

FIG. 2G is a three-dimensional view of the resilience wiring sheet according to the 1st Example of the 2nd Embodiment in FIG. 2A.

FIG. 2H is a side view of the resilience wiring sheet according to the 1st Example of the 2nd Embodiment in FIG. 2G.

FIG. 2I is an enlarged view of the resilience wiring sheet according to the 1st Example of the 2nd Embodiment in FIG. 2H.

FIG. 2J is a top view of the resilience wiring sheet according to the 1st Example of the 2nd Embodiment in FIG. 2A.

FIG. 2K is a parameter schematic view of the resilience wiring sheet according to the 1st Example of the 2nd Embodiment in FIG. 2A.

FIG. 2L is a partial enlarged view of the resilience wiring sheet according to the 1st Example of the 2nd Embodiment in FIG. 2K.

FIG. 2M is a three-dimensional view of a resilience wiring sheet according to the 2nd Example of the 2nd Embodiment in FIG. 2A.

FIG. 2N is a side view of the resilience wiring sheet according to the 2nd Example of the 2nd Embodiment in FIG. 2M.

FIG. 2O is a top view of the resilience wiring sheet according to the 2nd Example of the 2nd Embodiment in FIG. 2M.

FIG. 2P is a schematic view of an elastic portion according to the 2nd Example of the 2nd Embodiment in FIG. 2M.

FIG. 3A is a three-dimensional view of a camera module according to the 1st Example of the 3rd Embodiment of the present disclosure.

FIG. 3B is a top view of the camera module according to the 1st Example of the 3rd Embodiment in FIG. 3A.

FIG. 3C is a cross-sectional view of the camera module along a cross line 3C-3C according to the 1st Example of the 3rd Embodiment in FIG. 3B.

FIG. 3D is an exploded view of the camera module according to the 1st Example of the 3rd Embodiment in FIG. 3A.

FIG. 3E is another exploded view of the camera module according to the 1st Example of the 3rd Embodiment in FIG. 3A.

FIG. 3F is another exploded view of the camera module according to the 1st Example of the 3rd Embodiment in FIG. 3A.

FIG. 3G is a partial exploded view of the camera module according to the 1st Example of the 3rd Embodiment in FIG. 3E.

FIG. 3H is a partial exploded view of the camera module according to the 1st Example of the 3rd Embodiment in FIG. 3G.

FIG. 3I is a side view of the resilience wiring sheet according to the 1st Example of the 3rd Embodiment in FIG. 3A.

FIG. 3J is a partial enlarged view of the resilience wiring sheet according to the 1st Example of the 3rd Embodiment in FIG. 3I.

FIG. 3K is a top view of the resilience wiring sheet according to the 1st Example of the 3rd Embodiment in FIG. 3A.

FIG. 3L is a parameter schematic view of the resilience wiring sheet according to the 1st Example of the 3rd Embodiment in FIG. 3A.

FIG. 3M is a partial enlarged view of the resilience wiring sheet according to the 1st Example of the 3rd Embodiment in FIG. 3L.

FIG. 3N is a three-dimensional view of a resilience wiring sheet according to the 2nd Example of the 3rd Embodiment in FIG. 3A.

FIG. 3O is a side view of the resilience wiring sheet according to the 2nd Example of the 3rd Embodiment in FIG. 3N.

FIG. 3P is a top view of the resilience wiring sheet according to the 2nd Example of the 3rd Embodiment in FIG. 3N.

FIG. 3Q is a schematic view of an elastic portion according to the 2nd Example of the 3rd Embodiment in FIG. 3N.

FIG. 4A is a three-dimensional view of a lens carrier, a frame element and a resilience wiring sheet according to the 1st Example of the 4th Embodiment of the present disclosure.

FIG. 4B is an exploded view of the lens carrier, the frame element and the resilience wiring sheet according to the 1st Example of the 4th Embodiment in FIG. 4A.

FIG. 4C is a three-dimensional view of the resilience wiring sheet according to the 1st Example of the 4th Embodiment in FIG. 4A.

FIG. 4D is a side view of the resilience wiring sheet according to the 1st Example of the 4th Embodiment in FIG. 4C.

FIG. 4E is a top view of the resilience wiring sheet according to the 1st Example of the 4th Embodiment in FIG. 4C.

FIG. 4F is a schematic view of the elastic portion according to the 1st Example of the 4th Embodiment in FIG. 4C.

FIG. 5A is a schematic view of an electronic device according to the 5th Embodiment of the present disclosure.

FIG. 5B is another schematic view of the electronic device according to the 5th Embodiment in FIG. 5A.

FIG. 5C is a schematic view of an image captured via the electronic device according to the 5th Embodiment in FIG. 5A.

FIG. 5D is a schematic view of another image captured via the electronic device according to the 5th Embodiment in FIG. 5A.

FIG. 5E is a schematic view of another image captured via the electronic device according to the 5th Embodiment in FIG. 5A.

FIG. 6 is a schematic view of an electronic device according to the 6th Embodiment of the present disclosure.

FIG. 7A is a schematic view of an electronic device applied to a vehicle according to the 7th Embodiment of the present disclosure.

FIG. 7B is another schematic view of the electronic device configured on the vehicle according to the 7th Embodiment in FIG. 7A.

FIG. 7C is another schematic view of the electronic device configured on the vehicle according to the 7th Embodiment in FIG. 7A.

### DETAILED DESCRIPTION

The present disclosure provides an imaging lens driving module, which includes an imaging lens assembly, a lens carrier, a frame element, a ball set, a wiring substrate, a resilience wiring sheet and a driving unit. The imaging lens assembly has an optical axis, the lens carrier is configured to install the imaging lens assembly, and the frame element is disposed corresponding to the lens carrier. The ball set is disposed between the lens carrier and the frame element, wherein the ball set is physically contacted with the lens carrier and the frame element. The wiring substrate is disposed on an image side of the imaging lens assembly, the resilience wiring sheet is configured to connect the lens carrier and the wiring substrate, and the resilience wiring sheet includes a movable end, a fixed end, a connecting portion and an elastic portion. The movable end is coupled and fixed with the lens carrier without a movement relative to the lens carrier, the fixed end is coupled and fixed with the wiring substrate without a movement relative to the wiring substrate, and the connecting portion is connected to the movable end. The elastic portion connects the fixed end and the connecting portion, the elastic portion extends in a direction parallel to the optical axis, and the elastic portion includes at least two meandering branches. The at least two meandering branches extend in a direction towards the fixed end, and the at least two meandering branches overlap each other in a specific direction in view. The driving unit is configured to drive the lens carrier to move relative to the wiring substrate in a direction parallel to the optical axis or in a direction perpendicular to the optical axis, and the driving unit includes a first coil and a first magnetic element. The first coil is disposed at the movable end of the resilience wiring sheet, the first magnetic element is disposed on an assembling portion of the frame element, and the first magnetic element faces and is disposed corresponding to the first coil.

Therefore, the ball set provides a translational freedom for the lens carrier moving in a direction parallel to the optical axis and relative to the frame element, and the resilience wiring sheet can reduce or even offset the dragging force on the fixed end so as to improve the stability of the imaging lens driving module.

Specifically, the wiring substrate can be a printed circuit board (PCB), a flexible printed circuitboard (FPC), a rigid-flex board or a ceramic substrate, but not limited thereto. The resilience wiring sheet can be in a thin sheet shape, but not limited thereto. Moreover, when the movable end moves with the lens carrier for auto-focusing, both the connecting portion and the elastic portion can provide the deformation margin to ensure that the resilience wiring sheet would not be broken, and the fixed end would not be influenced by the dragging force. In detail, the movable end can be where the resilience wiring sheet and the lens carrier are adhered to each other, but not limited thereto. The fixed end can be where the resilience wiring sheet and the wiring substrate are welded to each other, but not limited thereto. The at least two meandering branches are in a wiggling curve shape, the so-called wiggling curve shape can be a paper clip shape, a crab claw shape, etc., and the specific direction can be a direction perpendicular to the optical axis or a direction perpendicular to the resilience wiring sheet, but not limited thereto. Furthermore, the shape design of the elastic portion is wide at the top and narrow at the bottom so that the ability to adsorb the dragging force of the resilience wiring sheet can be improved.

Further, the elastic portion of the resilience wiring sheet can further include a node. The at least two meandering branches extend in the direction towards the fixed end and converge at the node, the at least two meandering branches are diverged away from each other after converging at the node, and the at least two meandering branches further extend towards the fixed end and then approach each other. Therefore, it is favorable for the mechanical design taken into account the requirement of the electrical connection and the ability to buffer the dragging force. The mechanical strength of each of the at least two meandering branches connected to the node can be improved by disposing the node, so that the ability to adsorb the dragging force of the resilience wiring sheet can be improved during auto focusing (AF) or optical image stabilization (OIS) moving.

Moreover, the elastic portion can further include a reinforcing portion and an auxiliary constraint component. The reinforcing portion is connected to at least one of the at least two meandering branches, and the auxiliary constraint component is coupled with the reinforcing portion and the at least one of the at least two meandering branches, so that a second angle is formed between the reinforcing portion and the at least one of the at least two meandering branches. The mechanical strength of the meandering branches connected to the reinforcing portion can be improved by disposing the reinforcing portion so as to improve the ability to adsorb the dragging force of the resilience wiring sheet. Specifically, the reinforcing portion can be a side elevation surface extending from the meandering branches with a bending angle, but not limited thereto.

Furthermore, the resilience wiring sheet can further include a principal constraint component. The principal constraint component is coupled with the connecting portion and the elastic portion so that a first angle is formed between the connecting portion and the elastic portion. Therefore, it is favorable for limiting the bending degree of the resilience wiring sheet to meet the wiring design in a limited space so as to improve the space utilization efficiency.

Specifically, the principal constraint component can be an iron sheet with a bending angle to limit the bending degree of the resilience wiring sheet, but not limited thereto.

In detail, the driving unit can further include a second coil. The second coil is disposed on a surface of the wiring substrate, and the first magnetic element faces and is disposed corresponding to both the first coil and the second coil. Specifically, the Lorentz force generated by the electromagnetic interaction between the first coil and the first magnetic element pushes the lens carrier to move relative to the frame element in a direction parallel to the optical axis.

Moreover, the driving unit can further include a third coil and a second magnetic element. The third coil is disposed on the other surface of the wiring substrate, the second magnetic element is disposed on the other assembling portion of the frame element, the second magnetic element faces the third coil, and the second magnetic element is disposed corresponding to the third coil. Specifically, the Lorentz force generated by the electromagnetic interaction between the third coil and the second magnetic element pushes the frame element to move relative to the wiring substrate in a direction perpendicular to the optical axis.

Furthermore, the driving unit can be configured to drive the lens carrier to move relative to the frame element in a direction parallel to the optical axis. Therefore, the auto focusing function is achieved by the lens carrier carrying the first coil disposed at the movable end.

Further, the driving unit can be configured to drive the frame element to move relative to the wiring substrate in a direction perpendicular to the optical axis. Therefore, the optical image stabilization function is achieved by the frame element carrying the lens carrier. Specifically, the Lorentz force generated by the electromagnetic interaction between the second coil and the first magnetic element pushes the frame element to move relative to the wiring substrate in a direction perpendicular to the optical axis.

In detail, the resilience wiring sheet can include polyimide. Therefore, the electromagnetic interference can be reduced, and the mechanical property of the resilience wiring sheet can be improved.

Moreover, when a straight length of the elastic portion in a direction along the optical axis is D, and a total length of the at least two meandering branches is L, the following conditions can be satisfied: D<L; and 1.4<L/D<17. Therefore, the length setting range can enable the resilience wiring sheet to have a better ability to adsorb the dragging force. Further, when the straight length of the elastic portion in a direction along the optical axis is D, and the total length of the at least two meandering branches is L, the following condition can be satisfied: 2.1<L/D<14.3.

Furthermore, when a maximum width of the elastic portion closed to the connecting portion is Wc, and a minimum width of each of the at least two meandering branches closed to the fixed end is Wf, the following conditions can be satisfied: Wf<Wc; and 1.5<Wc/Wf<16. Therefore, the width setting range can enable the resilience wiring sheet to have a better ability to adsorb the dragging force. Further, when the maximum width of the elastic portion closed to the connecting portion is Wc, and the minimum width of each of the at least two meandering branches closed to the fixed end is Wf, the following condition can be satisfied: 1.9<Wc/Wf<12.7.

Moreover, when a shortest distance between the fixed end and the node in a direction parallel to the optical axis is Hn, and the straight length of the elastic portion in a direction along the optical axis is D, the following conditions can be satisfied: Hn<D; and 0.1≤Hn/D≤0.7. The ability to adsorb the dragging force of the resilience wiring sheet can be further improved though adjusting the Hn/D value. Further, when the shortest distance between the fixed end and the node in a direction parallel to the optical axis is Hn, and the straight length of the elastic portion in a direction along the optical axis is D, the following condition can be satisfied: 0.2≤Hn/D≤0.55.

Each of the aforementioned features of the imaging lens driving module can be utilized in various combinations for achieving the corresponding effects.

The present disclosure provides a camera module, which includes the aforementioned imaging lens driving module and an image sensor, and the image sensor corresponds to an image surface of the imaging lens assembly of the imaging lens driving module. Specifically, the image sensor can be installed on the wiring substrate of the imaging lens driving module, but not limited thereto.

The present disclosure provides an electronic device, which includes the aforementioned camera module.

According to the aforementioned embodiment, specific examples are provided, and illustrated via figures.

### 1st Embodiment

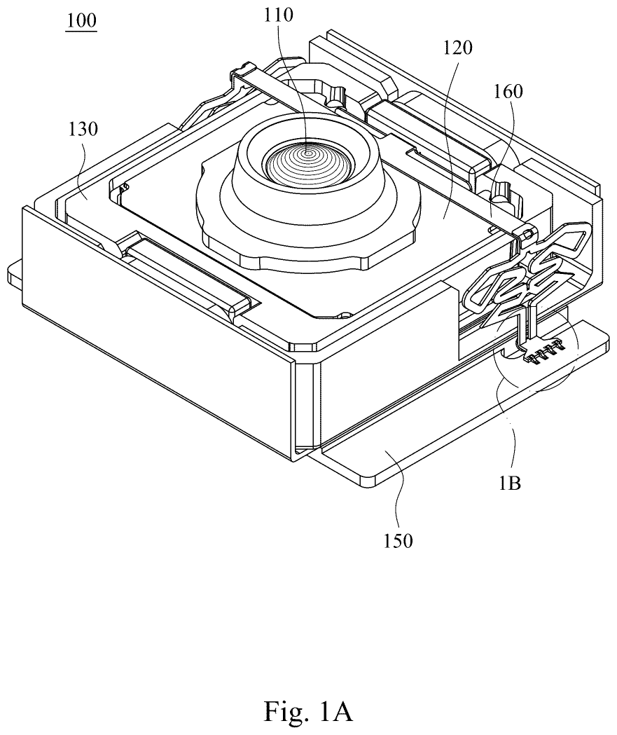

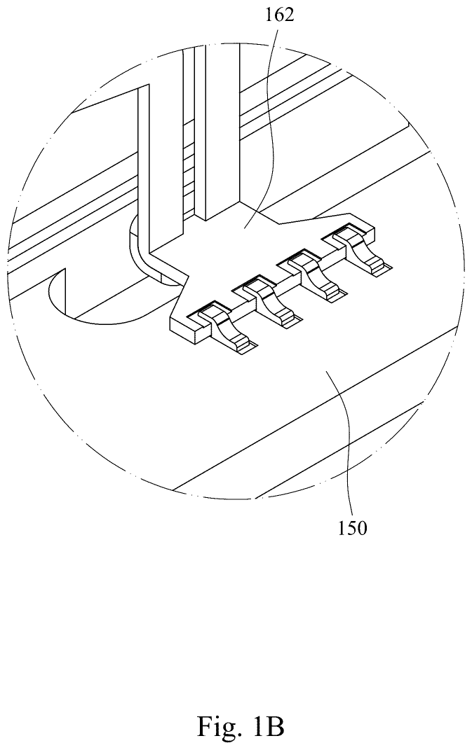

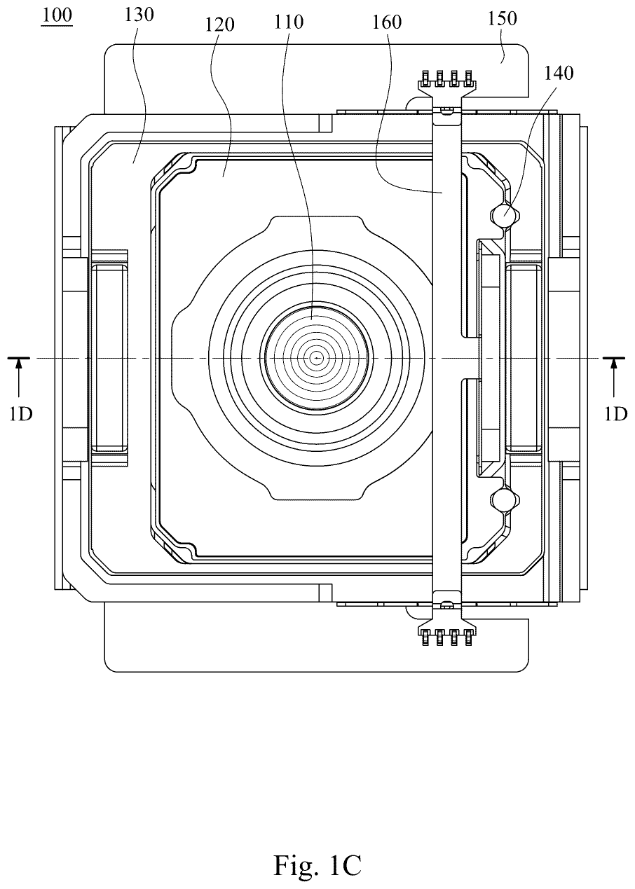

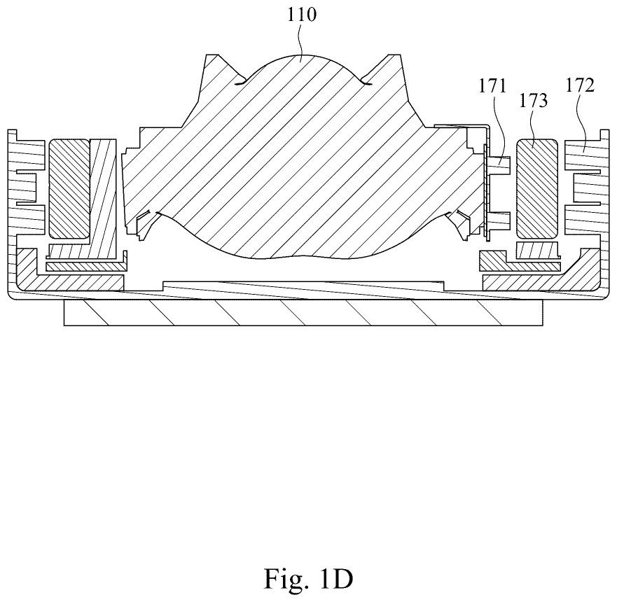

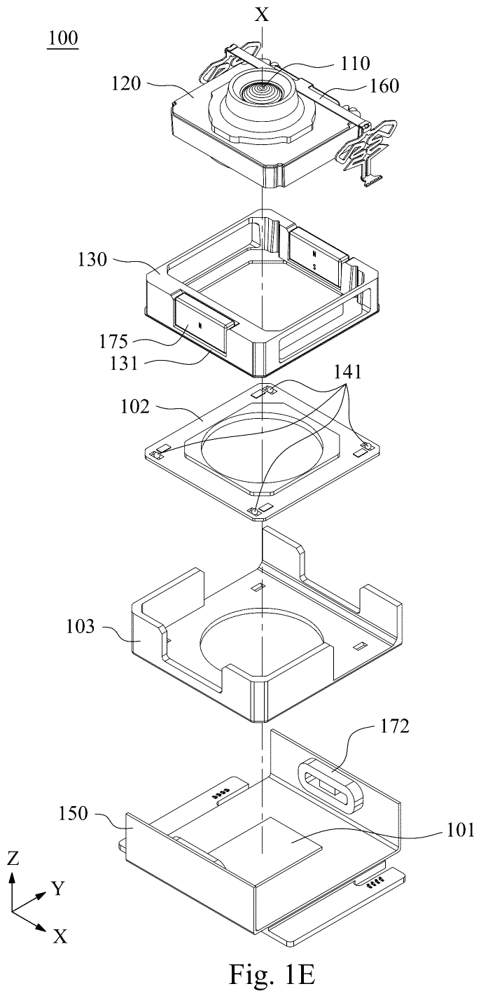

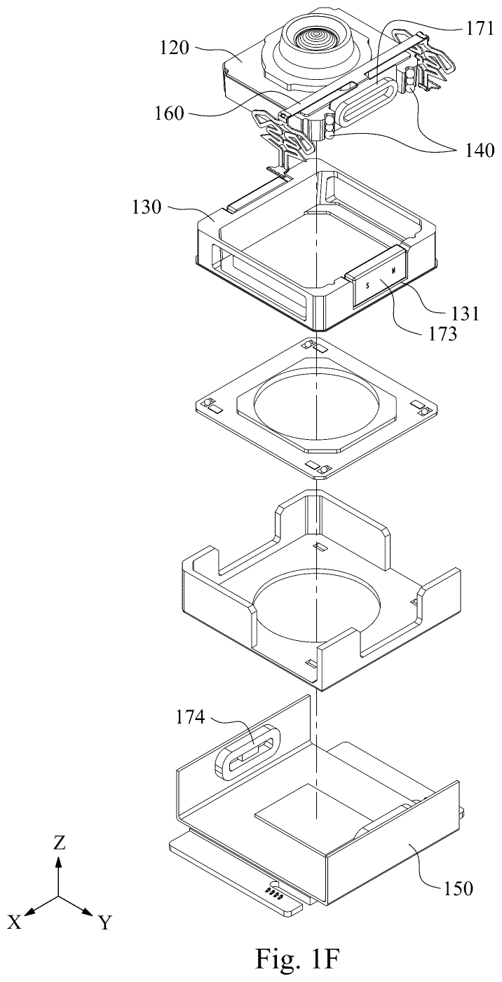

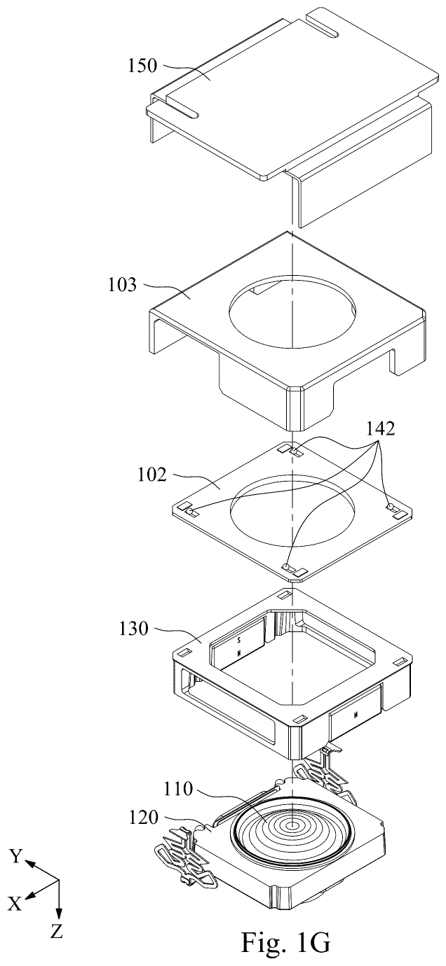

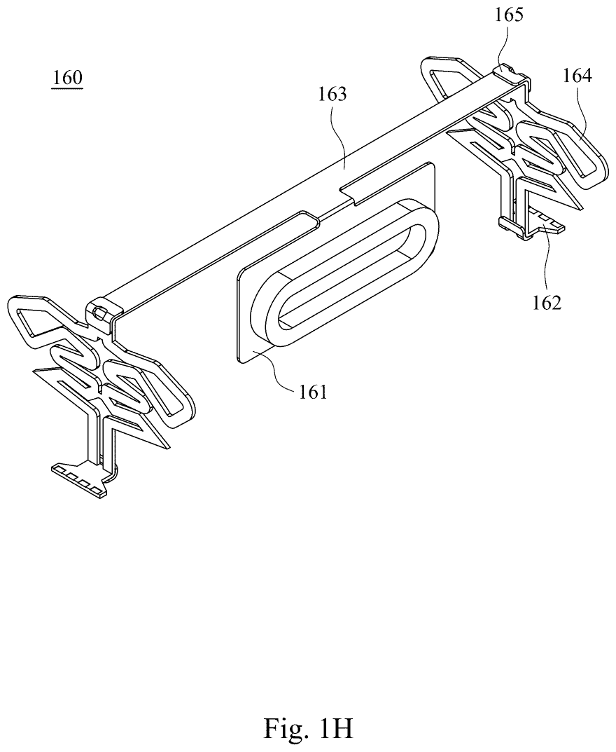

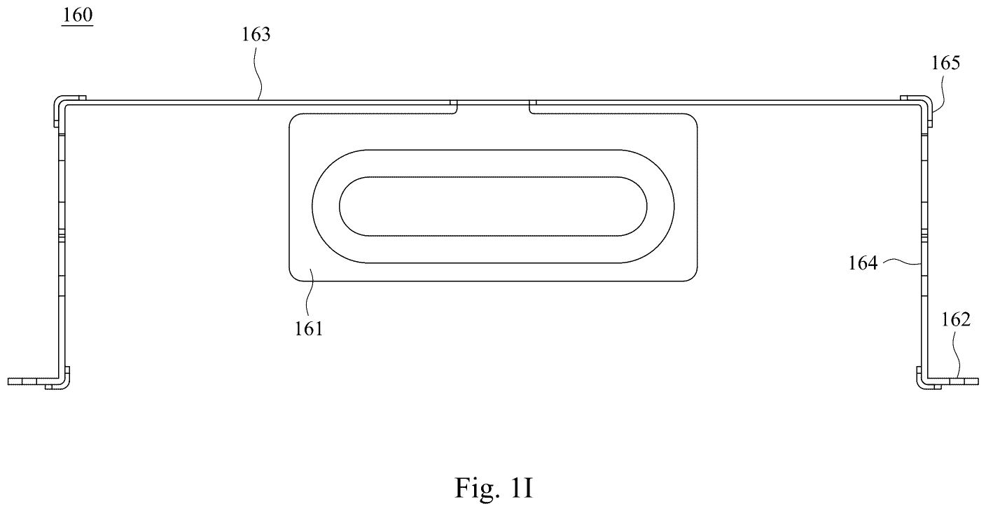

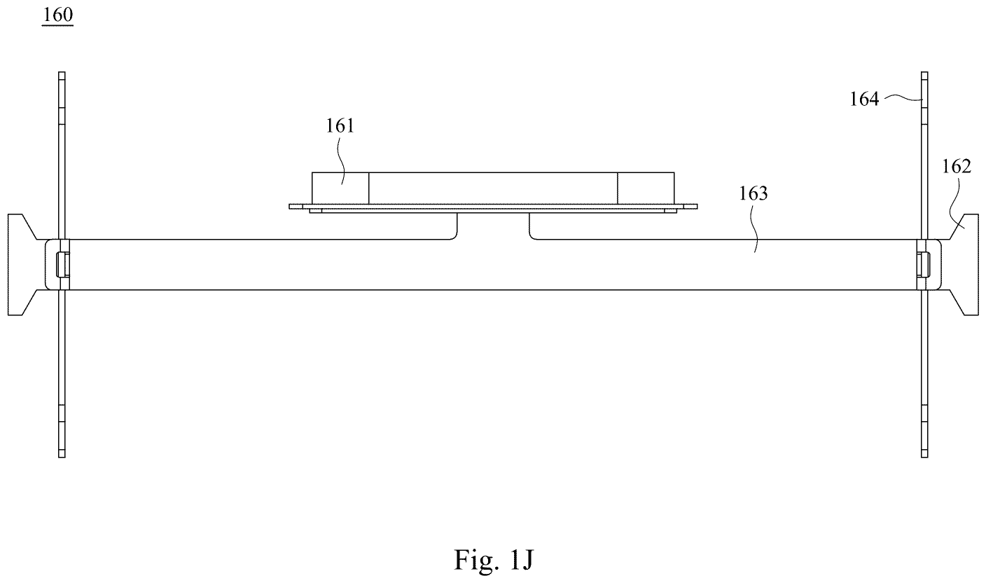

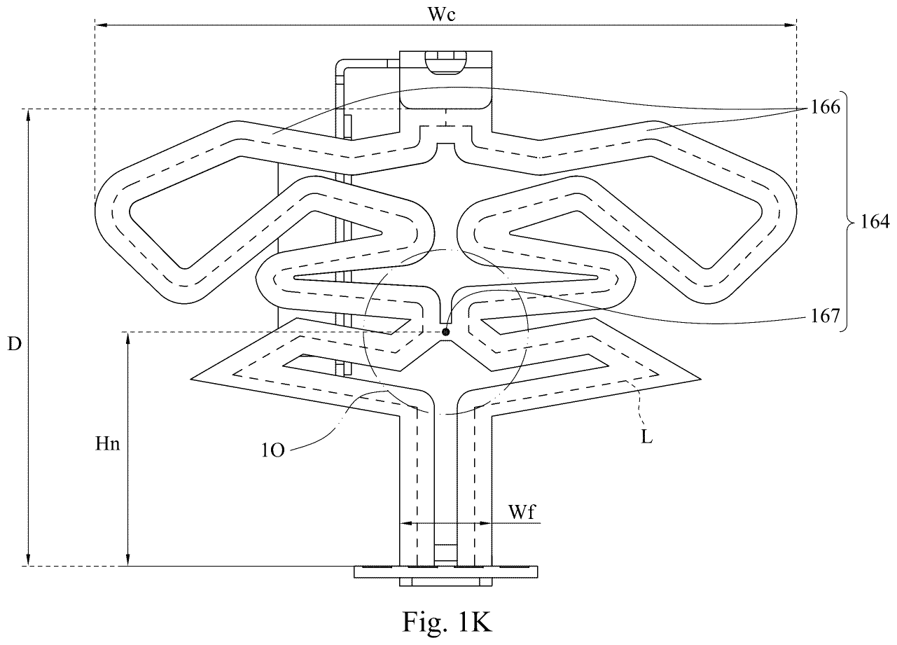

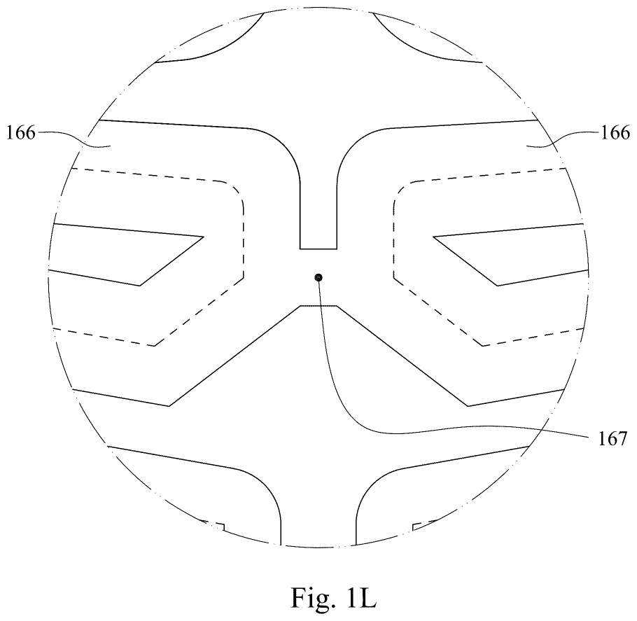

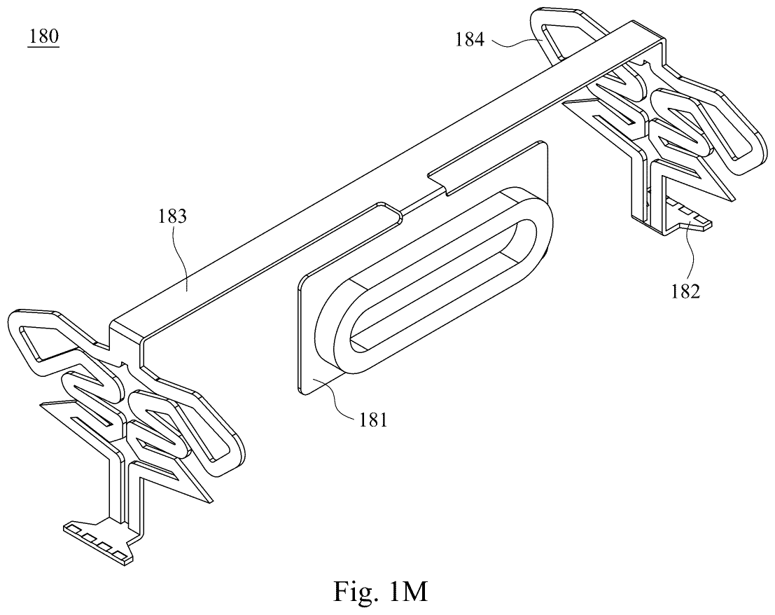

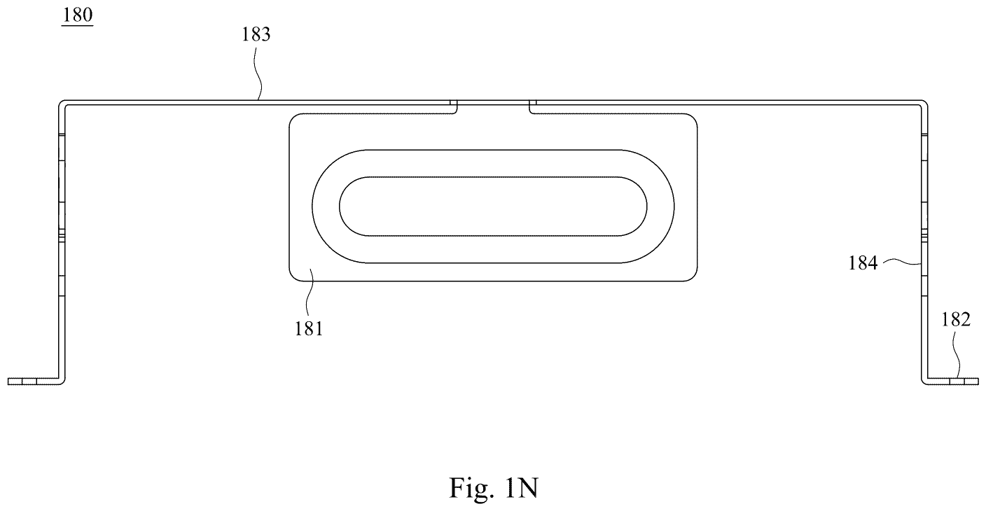

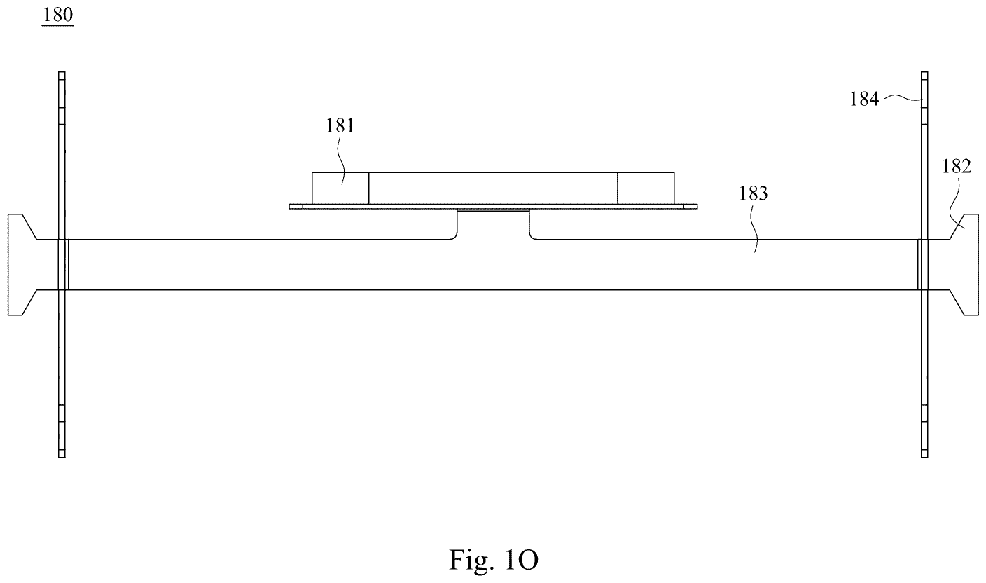

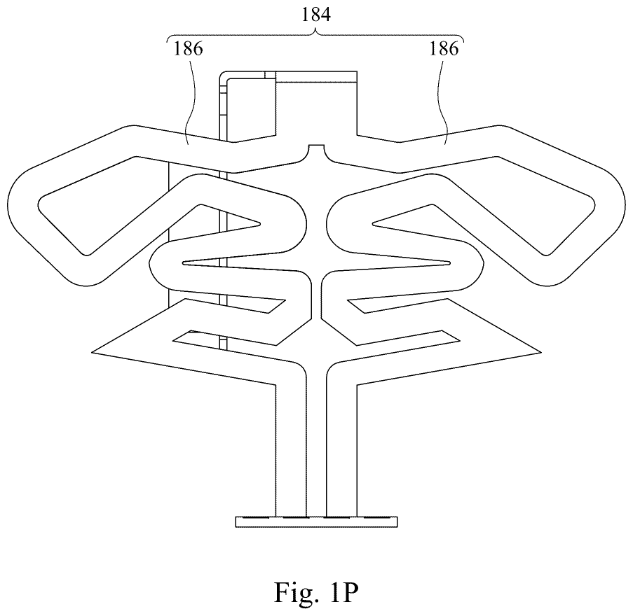

FIG. 1A is a three-dimensional view of a camera module 100 according to the 1st Example of the 1st Embodiment of the present disclosure, FIG. 1C is a top view of the camera module 100 according to the 1st Example of the 1st Embodiment in FIG. 1A, and FIG. 1E is an exploded view of the camera module 100 according to the 1st Example of the 1st Embodiment in FIG. 1A. In FIG. 1A, FIG. 1C and FIG. 1E, the camera module 100 includes an imaging lens driving module (its reference numeral is omitted) and an image sensor 101, and the image sensor 101 corresponds to an image surface (its reference numeral is omitted) of the imaging lens assembly 110 of the imaging lens driving module. The imaging lens driving module includes the imaging lens assembly 110, a lens carrier 120, a frame element 130, a ball set 140, a wiring substrate 150, a resilience wiring sheet 160 and a driving unit (its reference numeral is omitted). The imaging lens assembly 110 has an optical axis X, the lens carrier 120 is configured to install the imaging lens assembly 110, the frame element 130 is disposed corresponding to the lens carrier 120, and the wiring substrate 150 is disposed on the image side of the imaging lens assembly 110.

Specifically, the wiring substrate 150 can be a printed circuit board, a flexible printed circuitboard, a rigid-flex board or a ceramic substrate, but not limited thereto.

FIG. 1F is another exploded view of the camera module 100 according to the 1st Example of the 1st Embodiment in FIG. 1A, and FIG. 1G is another exploded view of the camera module 100 according to the 1st Example of the 1st Embodiment in FIG. 1A. In FIG. 1E to FIG. 1G, the ball set 140 is disposed between the lens carrier 120 and the frame element 130, wherein the ball set 140 is physically contacted with the lens carrier 120 and the frame element 130. In detail, the imaging lens driving module of the camera module 100 can further include a base 103, a movable plate 102, a first ball set 141 and a second ball set 142. The base 103 is disposed corresponding to the frame element 130, and the base 103 is coupled and fixed with the wiring substrate 150 without a movement relative to the wiring substrate 150. The movable plate 102 is disposed between the frame element 130 and the base 103. Moreover, the first ball set 141 is disposed between the frame element 130 and the movable plate 102, and the first ball set 141 provides a translational freedom for the frame element 130 moving in a direction perpendicular to the optical axis X and relative to the movable plate 102. The second ball set 142 is disposed between the movable plate 102 and the base 103, and the second ball set 142 provides another translational freedom for the movable plate 102 moving in a direction perpendicular to the optical axis X and relative to the base 103.

FIG. 1B is a partial enlarged view of the camera module 100 according to the 1st Example of the 1st Embodiment in FIG. 1A, FIG. 1H is a three-dimensional view of the resilience wiring sheet 160 according to the 1st Example of the 1st Embodiment in FIG. 1A, FIG. 1I is a side view of the resilience wiring sheet 160 according to the 1st Example of the 1st Embodiment in FIG. 1H, FIG. 1J is a top view of the resilience wiring sheet 160 according to the 1st Example of the 1st Embodiment in FIG. 1H, FIG. 1K is a parameter schematic view of the resilience wiring sheet 160 according to the 1st Example of the 1st Embodiment in FIG. 1A, and FIG. 1L is a partial enlarged view of the resilience wiring sheet 160 according to the 1st Example of the 1st Embodiment in FIG. 1K. In FIG. 1A, FIG. 1B, FIG. 1F, FIG. 1H to FIG. 1L, the resilience wiring sheet 160 is configured to connect the lens carrier 120 and the wiring substrate 150, and the resilience wiring sheet 160 includes a movable end 161, two fixed ends 162, a connecting portion 163, two elastic portions 164 and a principal constraint component 165. The movable end 161 is coupled and fixed with the lens carrier 120 without a movement relative to the lens carrier 120, the two fixed ends 162 are coupled and fixed with the wiring substrate 150 without a movement relative to the wiring substrate 150, and the connecting portion 163 is connected to the movable end 161. Further, the principal constraint component 165 is coupled with the connecting portion 163 and the two elastic portions 164 so that a first angle is formed between the connecting portion 163 and the two elastic portions 164. Furthermore, the resilience wiring sheet 160 can include polyimide.

Specifically, the resilience wiring sheet 160 can be in a thin sheet shape, but not limited thereto. The movable end 161 can be where the resilience wiring sheet 160 and the lens carrier 120 are adhered to each other, but not limited thereto. The principal constraint component 165 can be an iron sheet with a bending angle to limit the bending degree of the resilience wiring sheet 160, but not limited thereto. In FIG. 1B, the two fixed ends 162 can be where the resilience wiring sheet 160 and the wiring substrate 150 are welded to each other, but not limited thereto. Moreover, the two fixed ends 162 and the wiring substrate 150 can be fixed via a solder, but not limited thereto.

In FIG. 1H to FIG. 1L, the two elastic portions 164 respectively connect the two fixed ends 162 and two ends of the connecting portion 163, the two elastic portions 164 extend in a direction parallel to the optical axis X, and each of the two elastic portions 164 includes at least two meandering branches 166 and a node 167. The at least two meandering branches 166 of each of the two elastic portions 164 extend in a direction towards one of the two fixed ends 162, the at least two meandering branches 166 overlap each other in a specific direction in view, and the at least two meandering branches 166 extend in the direction towards one of the two fixed ends 162 and converge at the node 167. Further, the at least two meandering branches 166 of each of the two elastic portions 164 are diverged away from each other after converging at the node 167, and the at least two meandering branches 166 further extend towards one of the two fixed ends 162 and then approach each other. Specifically, the at least two meandering branches 166 are in a wiggling curve shape, the so-called wiggling curve shape can be a paper clip shape, a crab claw shape, etc., and the specific direction can be a direction perpendicular to the optical axis X or a direction perpendicular to the resilience wiring sheet 160, but not limited thereto. Furthermore, the shape design of each of the elastic portions 164 is wide at the top and narrow at the bottom so that the ability to adsorb the dragging force of the resilience wiring sheet 160 can be improved.

FIG. 1D is a cross-sectional view of the 1st Example of the 1st Embodiment along a cross line 1D-1D in FIG. 1C. In FIG. 1C, FIG. 1D, FIG. 1E and FIG. 1F, the driving unit is configured to drive the lens carrier 120 to move relative to the wiring substrate 150 in a direction parallel to the optical axis X or in a direction perpendicular to the optical axis X, and the driving unit includes a first coil 171, a second coil 172 and a first magnetic element 173. The first coil 171 is disposed at the movable end 161 of the resilience wiring sheet 160, the second coil 172 is disposed on a surface of the wiring substrate 150, the first magnetic element 173 is disposed on an assembling portion 131 of the frame element 130, and the first magnetic element 173 faces and is disposed corresponding to both the first coil 171 and the second coil 172. Moreover, the driving unit can further include a third coil 174 and a second magnetic element 175. The third coil 174 is disposed on the other surface of the wiring substrate 150, the second magnetic element 175 is disposed on the other assembling portion 131 of the frame element 130, the second magnetic element 175 faces the third coil 174, and the second magnetic element 175 is disposed corresponding to the third coil 174.

In detail, the driving unit can be configured to drive the lens carrier 120 to move relative to the frame element 130 in a direction parallel to the optical axis X, and the driving unit can be configured to drive the frame element 130 to move relative to the wiring substrate 150 in a direction perpendicular to the optical axis X.

Specifically, the Lorentz force generated by the electromagnetic interaction between the first coil 171 and the first magnetic element 173 pushes the lens carrier 120 to move relative to the frame element 130 in a direction parallel to the optical axis X. The Lorentz force generated by the electromagnetic interaction between the second coil 172 and the first magnetic element 173 pushes the frame element 130 to move relative to the wiring substrate 150 in a direction perpendicular to the optical axis X. Furthermore, the Lorentz force generated by the electromagnetic interaction between the third coil 174 and the second magnetic element 175 pushes the frame element 130 to move relative to the wiring substrate 150 in a direction perpendicular to the optical axis X.

In FIG. 1K, when a straight length of one of the two elastic portions 164 in a direction along the optical axis X is D, a total length of the at least two meandering branches 166 is L, a maximum width of one of the two elastic portions 164 closed to the connecting portion 163 is Wc, a minimum width of each of the at least two meandering branches 166 closed to one of the two fixed ends 162 is Wf, and a shortest distance between one of the two fixed ends 162 and the node 167 in a direction parallel to the optical axis X is Hn, the mentioned parameters satisfy the following conditions in Table 1.

TABLE 1

| | | | |
|---|---|---|---|
| D (mm) | 5.548 | Hn (mm) | 2.841 |
| L (mm) | 40.340 | L/D | 7.27 |
| Wc (mm) | 8.515 | Wc/Wf | 7.62 |
| Wf (mm) | 1.118 | Hn/D | 0.51 |

FIG. 1M is a three-dimensional view of a resilience wiring sheet 180 according to the 2nd Example of the 1st Embodiment in FIG. 1A, FIG. 1N is a side view of the resilience wiring sheet 180 according to the 2nd Example of the 1st Embodiment in FIG. 1M, FIG. 1O is a top view of the resilience wiring sheet 180 according to the 2nd Example of the 1st Embodiment in FIG. 1M, and FIG. 1P is a schematic view of an elastic portion 184 according to the 2nd Example of the 1st Embodiment in FIG. 1M. In FIG. 1M to FIG. 1P, the resilience wiring sheet 180 according to the 2nd Example of the 1st Embodiment is similar to the resilience wiring sheet 160 according to the 1st Example of the 1st Embodiment, the difference is that the resilience wiring sheet 180 includes a movable end 181, two fixed ends 182, a connecting portion 183 and two elastic portions 184. The two elastic portions 184 respectively connect the two fixed ends 182 and two ends of the connecting portion 183, wherein each of the two elastic portions 184 includes at least two meandering branches 186. The at least two meandering branches 186 extend in a direction towards one of the two fixed ends 182, and the at least two meandering branches 186 overlap each other in a specific direction in view.

The structures, positions and connection relationships of the other elements according to the 2nd Example of the 1st Embodiment are the same as or similar to the elements according to the 1st Example of the 1st Embodiment, and will not describe again herein.

### 2nd Embodiment

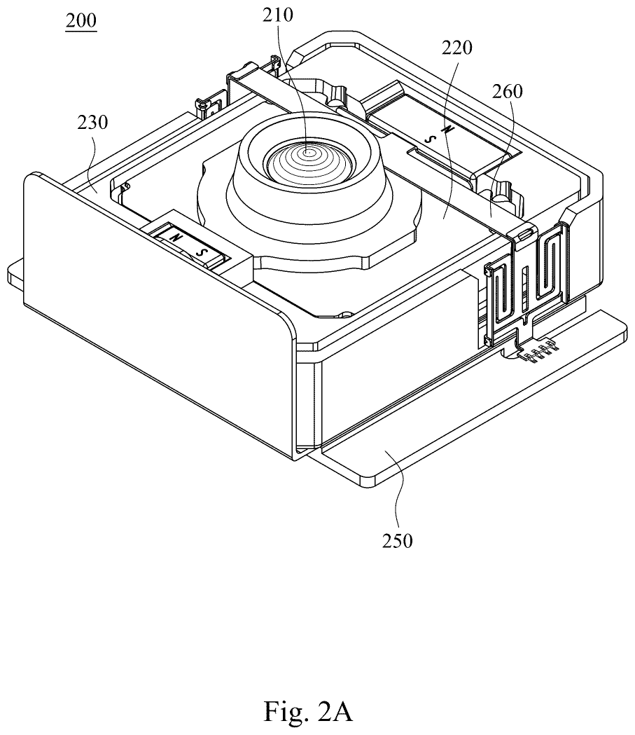

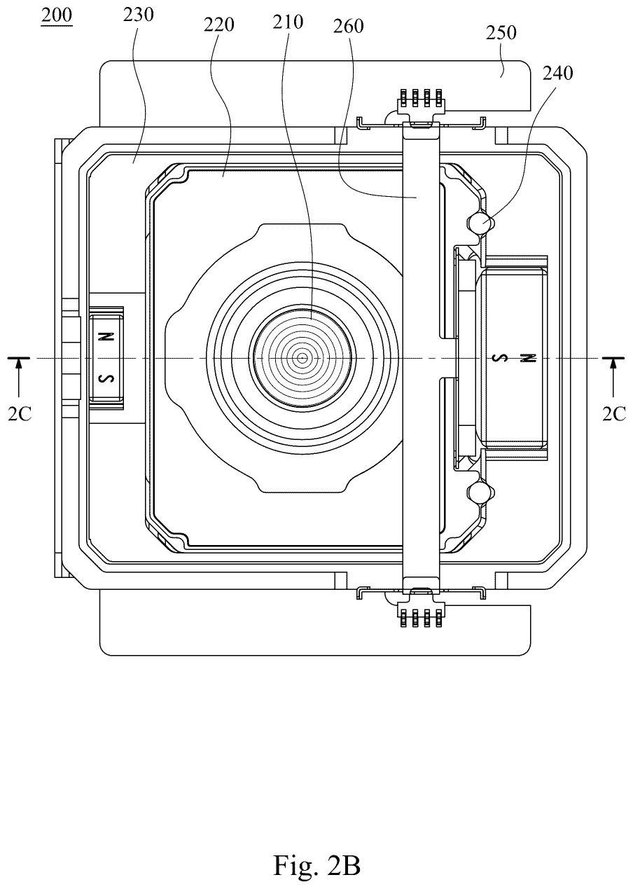

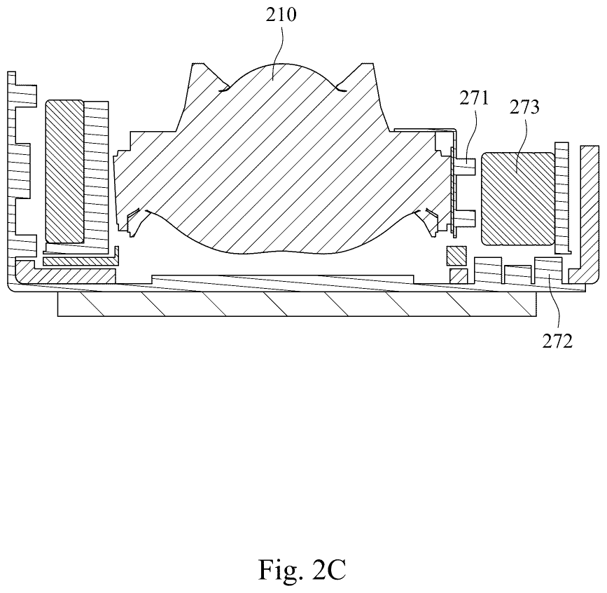

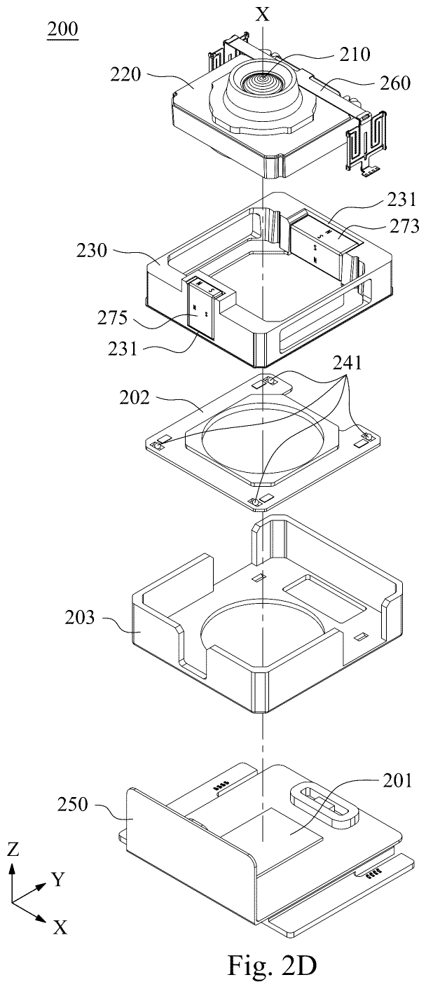

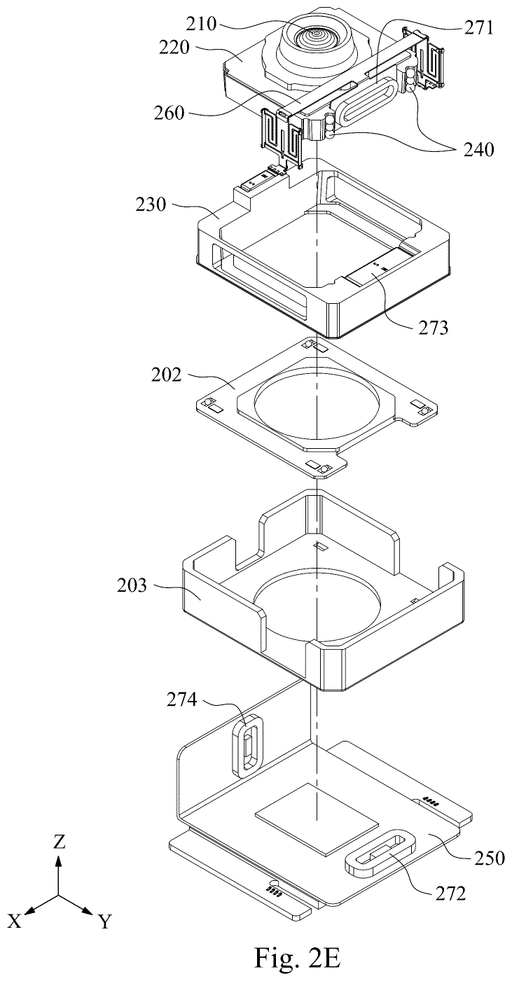

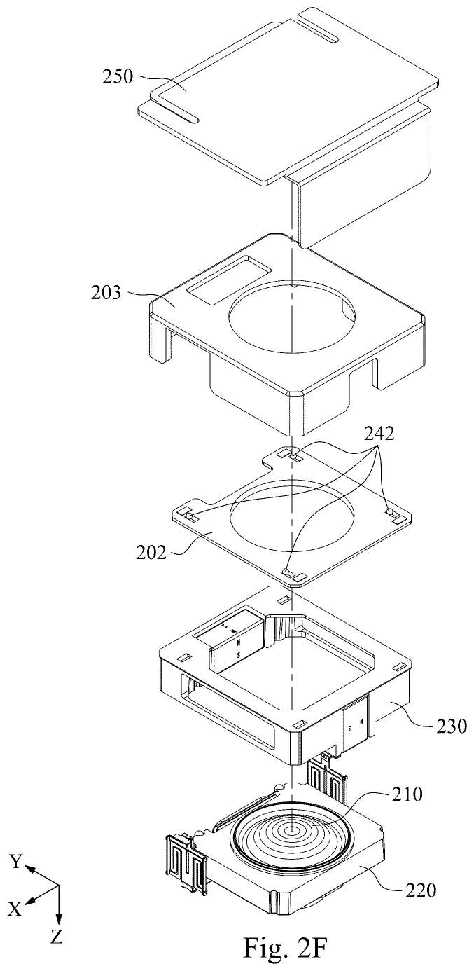

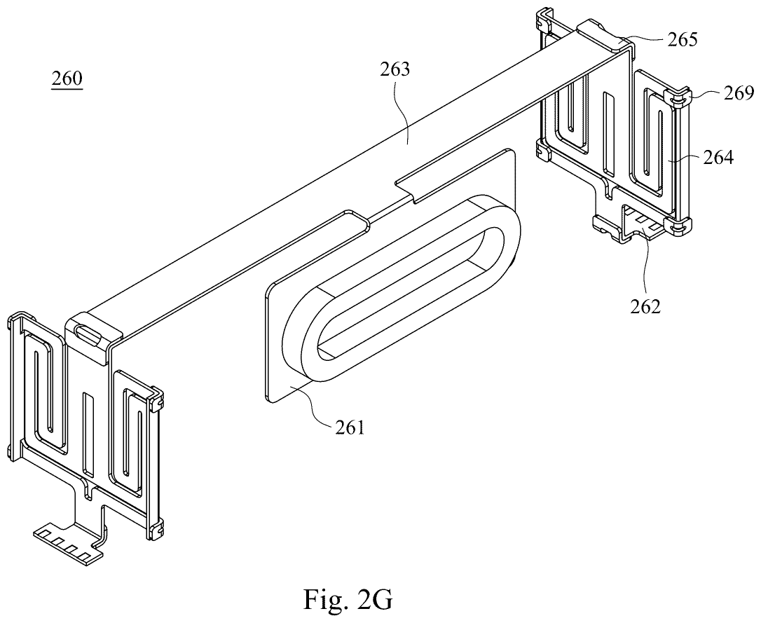

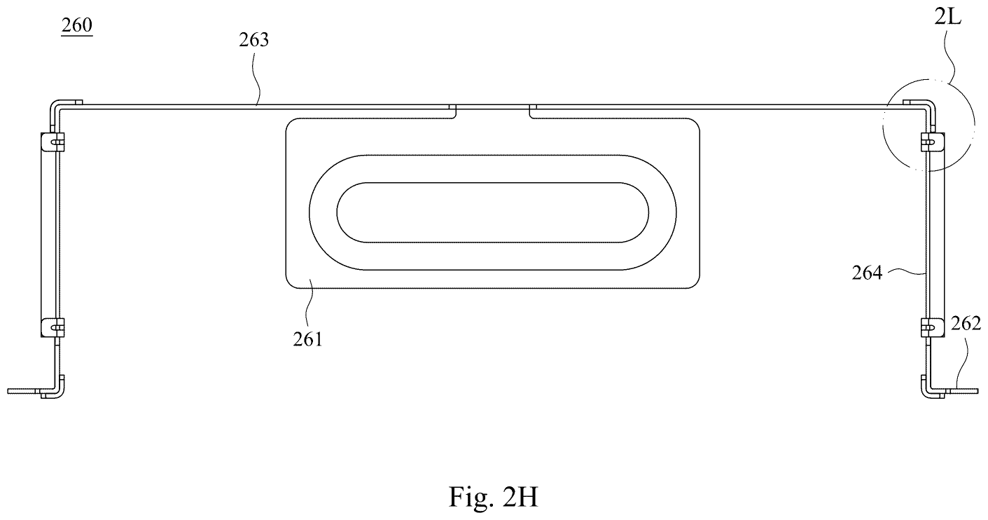

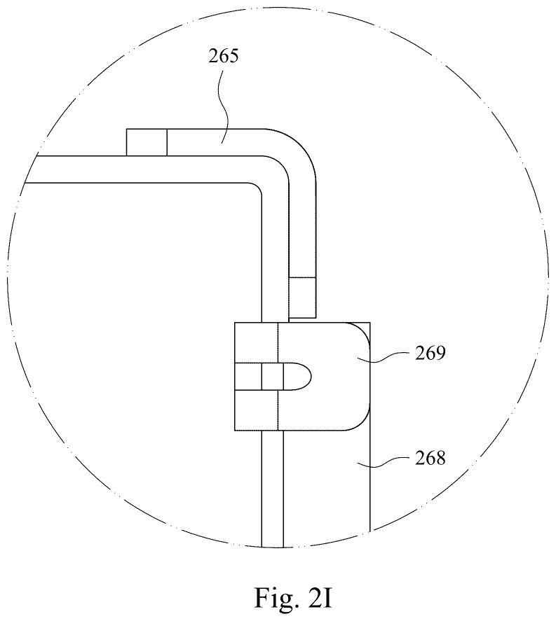

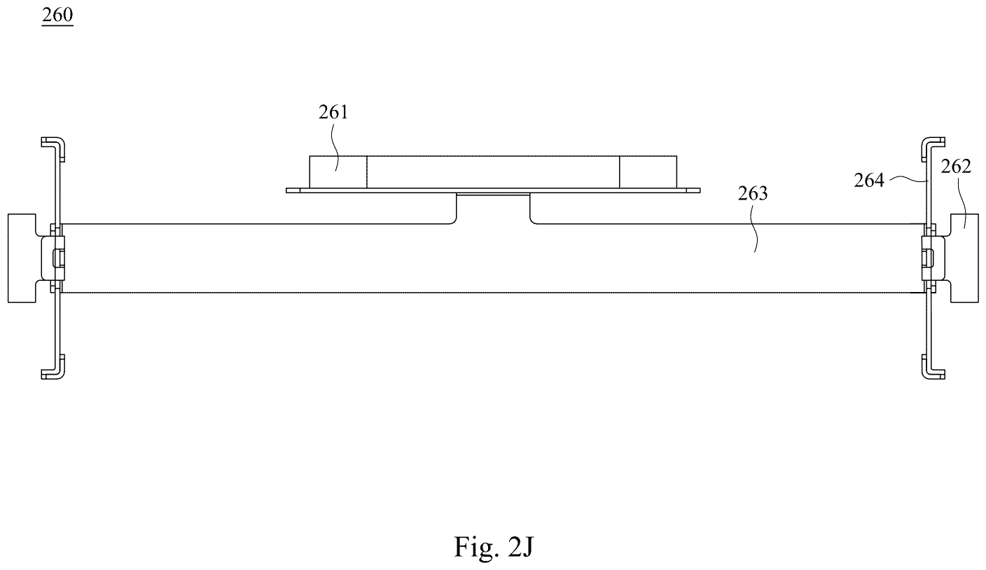

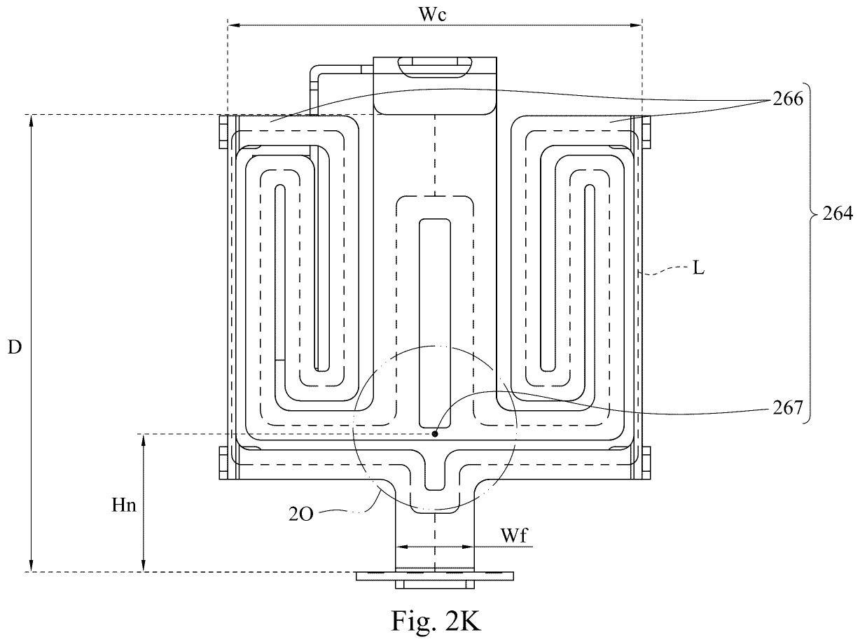

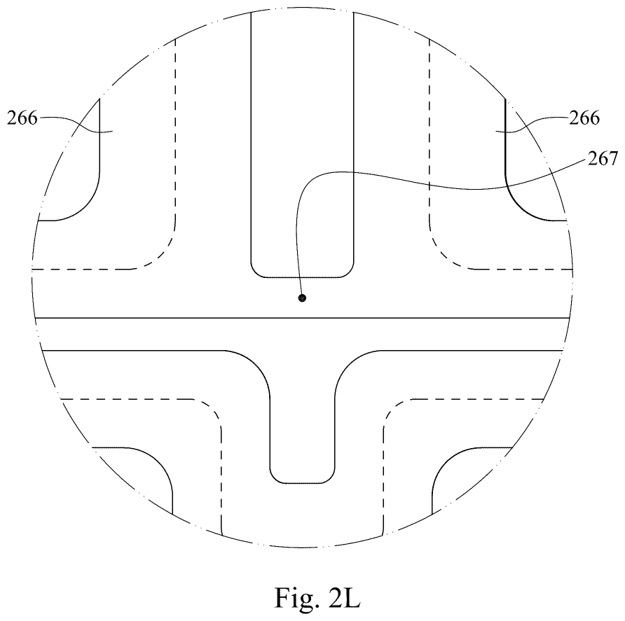

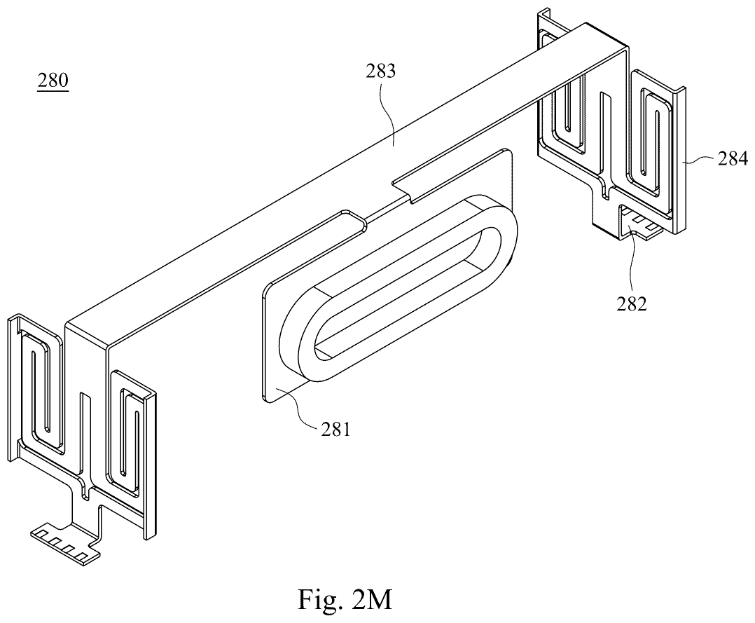

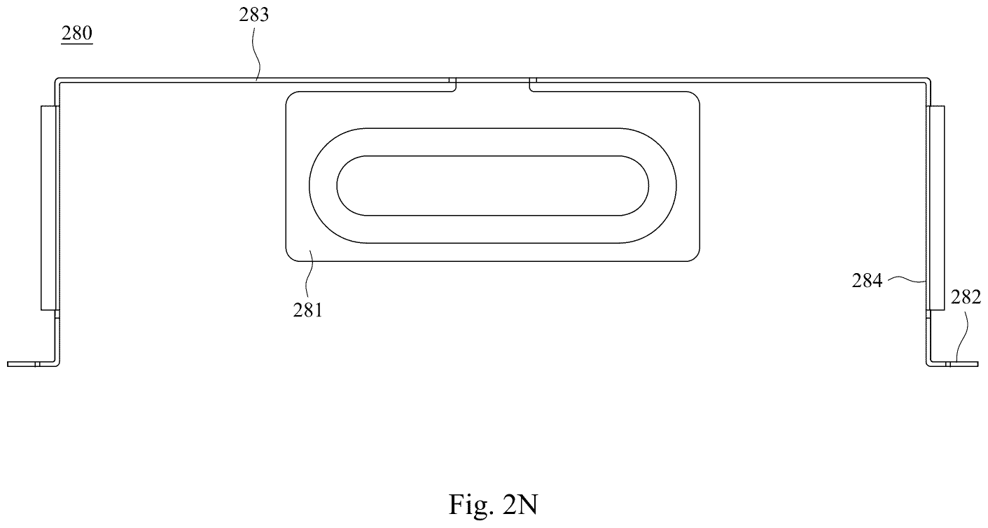

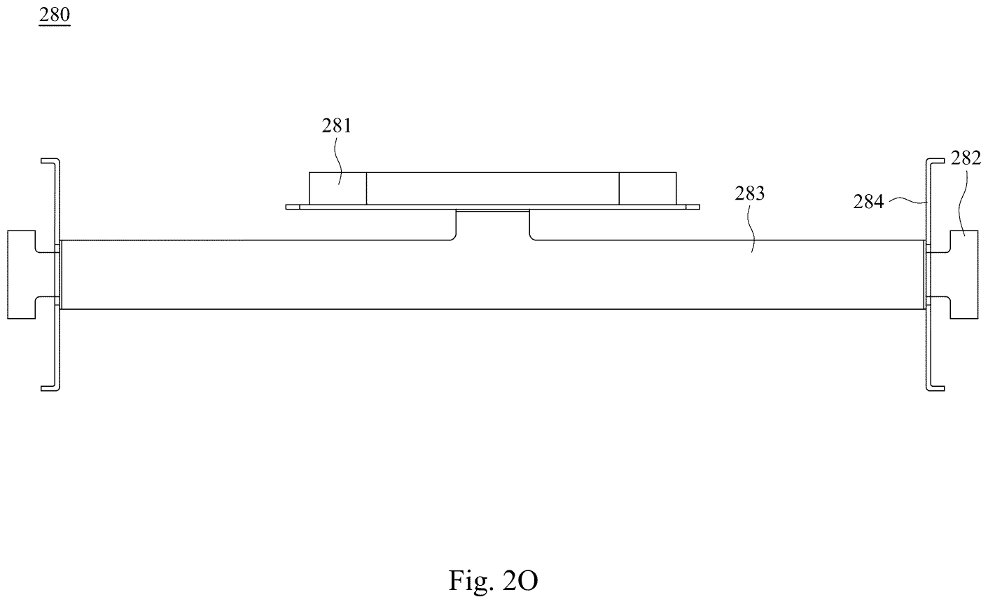

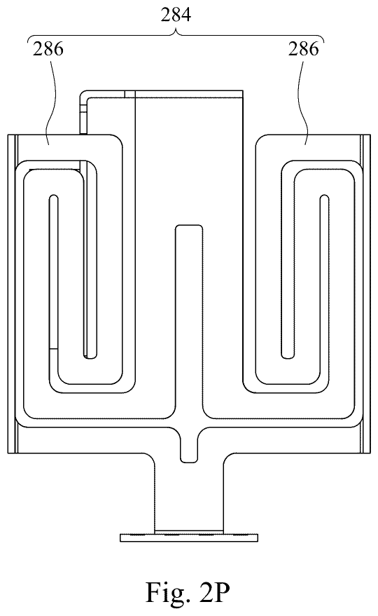

FIG. 2A is a three-dimensional view of a camera module 200 according to the 1st Example of the 2nd Embodiment of the present disclosure, FIG. 2B is a top view of the camera module 200 according to the 1st Example of the 2nd Embodiment in FIG. 2A, and FIG. 2D is an exploded view of the camera module 200 according to the 1st Example of the 2nd Embodiment in FIG. 2A. In FIG. 2A, FIG. 2B and FIG. 2D, the camera module 200 includes an imaging lens driving module (its reference numeral is omitted) and an image sensor 201, and the image sensor 201 corresponds to an image surface (its reference numeral is omitted) of the imaging lens assembly 210 of the imaging lens driving module. The imaging lens driving module includes the imaging lens assembly 210, a lens carrier 220, a frame element 230, a ball set 240, a wiring substrate 250, a resilience wiring sheet 260 and a driving unit (its reference numeral is omitted). The imaging lens assembly 210 has an optical axis X, the lens carrier 220 is configured to install the imaging lens assembly 210, the frame element 230 is disposed corresponding to the lens carrier 220, and the wiring substrate 250 is disposed on the image side of the imaging lens assembly 210.

Specifically, the wiring substrate 250 can be a printed circuit board, a flexible printed circuitboard, a rigid-flex board or a ceramic substrate, but not limited thereto.

FIG. 2D is an exploded view of the camera module 200 according to the 1st Example of the 2nd Embodiment in FIG. 2A, FIG. 2E is another exploded view of the camera module 200 according to the 1st Example of the 2nd Embodiment in FIG. 2A, and FIG. 2F is another exploded view of the camera module 200 according to the 1st Example of the 2nd Embodiment in FIG. 2A. In FIG. 2D to FIG. 2F, the ball set 240 is disposed between the lens carrier 220 and the frame element 230, wherein the ball set 240 is physically contacted with the lens carrier 220 and the frame element 230. In detail, the imaging lens driving module of the camera module 200 can further include a base 203, a movable plate 202, a first ball set 241 and a second ball set 242. The base 203 is disposed corresponding to the frame element 230, and the base 203 is coupled and fixed with the wiring substrate 250 without a movement relative to the wiring substrate 250. The movable plate 202 is disposed between the frame element 230 and the base 203. Moreover, the first ball set 241 is disposed between the frame element 230 and the movable plate 202, and the first ball set 241 provides a translational freedom for the frame element 230 moving in a direction perpendicular to the optical axis X and relative to the movable plate 202. The second ball set 242 is disposed between the movable plate 202 and the base 203, and the second ball set 242 provides another translational freedom for the movable plate 202 moving in a direction perpendicular to the optical axis X and relative to the base 203.

FIG. 2G is a three-dimensional view of the resilience wiring sheet 260 according to the 1st Example of the 2nd Embodiment in FIG. 2A, FIG. 2H is a side view of the resilience wiring sheet 260 according to the 1st Example of the 2nd Embodiment in FIG. 2G, FIG. 2I is an enlarged view of the resilience wiring sheet 260 according to the 1st Example of the 2nd Embodiment in FIG. 2H, FIG. 2J is a top view of the resilience wiring sheet 260 according to the 1st Example of the 2nd Embodiment in FIG. 2A, FIG. 2K is a parameter schematic view of the resilience wiring sheet 260 according to the 1st Example of the 2nd Embodiment in FIG. 2A, and FIG. 2L is a partial enlarged view of the resilience wiring sheet 260 according to the 1st Example of the 2nd Embodiment in FIG. 2K. In FIG. 2A, FIG. 2B, FIG. 2E, FIG. 2G to FIG. 2L, the resilience wiring sheet 260 is configured to connect the lens carrier 220 and the wiring substrate 250, and the resilience wiring sheet 260 includes a movable end 261, two fixed ends 262, a connecting portion 263, two elastic portions 264 and a principal constraint component 265. The movable end 261 is coupled and fixed with the lens carrier 220 without a movement relative to the lens carrier 220, the two fixed ends 262 are coupled and fixed with the wiring substrate 250 without a movement relative to the wiring substrate 250, and the connecting portion 263 is connected to the movable end 261. Further, the principal constraint component 265 is coupled with the connecting portion 263 and the two elastic portions 264 so that a first angle is formed between the connecting portion 263 and the two elastic portions 264. Furthermore, the resilience wiring sheet 260 can include polyimide.

Specifically, the resilience wiring sheet 260 can be in a thin sheet shape, but not limited thereto. The movable end 261 can be where the resilience wiring sheet 260 and the lens carrier 220 are adhered to each other, but not limited thereto. The principal constraint component 265 can be an iron sheet with a bending angle to limit the bending degree of the resilience wiring sheet 260, but not limited thereto. The two fixed ends 262 can be where the resilience wiring sheet 260 and the wiring substrate 250 are welded to each other, but not limited thereto.

In FIG. 2H to FIG. 2L, the two elastic portions 264 respectively connect the two fixed ends 262 and two ends of the connecting portion 263, the two elastic portions 264 extend in a direction parallel to the optical axis X, and each of the two elastic portions 264 includes at least two meandering branches 266 and a node 267. The at least two meandering branches 266 of each of the two elastic portions 264 extend in a direction towards one of the two fixed ends 262, the at least two meandering branches 266 overlap each other in a specific direction in view, and the at least two meandering branches 266 extend in the direction towards one of the two fixed ends 262 and converge at the node 267. Specifically, the at least two meandering branches 266 are in a wiggling curve shape, the so-called wiggling curve shape can be a paper clip shape, a crab claw shape, etc., and the specific direction can be a direction perpendicular to the optical axis X or a direction perpendicular to the resilience wiring sheet 260, but not limited thereto. Furthermore, the shape design of each of the elastic portions 264 is wide at the top and narrow at the bottom so that the ability to adsorb the dragging force of the resilience wiring sheet 260 can be improved.

Moreover, each of the two elastic portions 264 can further include a reinforcing portion 268 and an auxiliary constraint component 269. The reinforcing portion 268 is connected to at least one of the at least two meandering branches 266 of each of the two elastic portions 264, and the auxiliary constraint component 269 is coupled with the reinforcing portion 268 and the at least one of the at least two meandering branches 266, so that a second angle is formed between the reinforcing portion 268 and the at least one of the at least two meandering branches 266. Specifically, the reinforcing portion 268 can be a side elevation surface extending from the meandering branches 266 with a bending angle, but not limited thereto.

FIG. 2C is a cross-sectional view of the camera module 200 along a cross line 2C-2C according to the 1st Example of the 2nd Embodiment in FIG. 2B. In FIG. 2B, FIG. 2C, FIG. 2D and FIG. 2F, the driving unit is configured to drive the lens carrier 220 to move relative to the wiring substrate 250 in a direction parallel to the optical axis X or in a direction perpendicular to the optical axis X, and the driving unit includes a first coil 271, a second coil 272 and a first magnetic element 273. The first coil 271 is disposed at the movable end 261 of the resilience wiring sheet 260, the second coil 272 is disposed on a surface of the wiring substrate 250, the first magnetic element 273 is disposed on an assembling portion 231 of the frame element 230, and the first magnetic element 273 faces and is disposed corresponding to both the first coil 271 and the second coil 272. Moreover, the driving unit can further include a third coil 274 and a second magnetic element 275. The third coil 274 is disposed on the other surface of the wiring substrate 250, the second magnetic element 275 is disposed on the other assembling portion 231 of the frame element 230, the second magnetic element 275 faces the third coil 274, and the second magnetic element 275 is disposed corresponding to the third coil 274.

In detail, the driving unit can be configured to drive the lens carrier 220 to move relative to the frame element 230 in a direction parallel to the optical axis X, and the driving unit can be configured to drive the frame element 230 to move relative to the wiring substrate 250 in a direction perpendicular to the optical axis X.

Specifically, the Lorentz force generated by the electromagnetic interaction between the first coil 271 and the first magnetic element 273 pushes the lens carrier 220 to move relative to the frame element 230 in a direction parallel to the optical axis X. The Lorentz force generated by the electromagnetic interaction between the second coil 272 and the first magnetic element 273 pushes the frame element 230 to move relative to the wiring substrate 250 in a direction perpendicular to the optical axis X. Furthermore, the Lorentz force generated by the electromagnetic interaction between the third coil 274 and the second magnetic element 275 pushes the frame element 230 to move relative to the wiring substrate 250 in a direction perpendicular to the optical axis X.

In FIG. 2K, when a straight length of one of the two elastic portions 264 in a direction along the optical axis X is D, a total length of the at least two meandering branches 266 is L, a maximum width of one of the two elastic portions 264 closed to the connecting portion 263 is Wc, a minimum width of each of the at least two meandering branches 266 closed to one of the two fixed ends 262 is Wf, and a shortest distance between one of the two fixed ends 262 and the node 267 in a direction parallel to the optical axis X is Hn, the mentioned parameters satisfy the following conditions in Table 2.

TABLE 2

| | | | |
|---|---|---|---|
| D (mm) | 5.588 | Hn (mm) | 1.687 |
| L (mm) | 47.081 | L/D | 8.43 |
| Wc (mm) | 5.06 | Wc/Wf | 5.27 |
| Wf (mm) | 0.96 | Hn/D | 0.30 |

FIG. 2M is a three-dimensional view of a resilience wiring sheet 280 according to the 2nd Example of the 2nd Embodiment in FIG. 2A, FIG. 2N is a side view of the resilience wiring sheet 280 according to the 2nd Example of the 2nd Embodiment in FIG. 2M, FIG. 2O is a top view of the resilience wiring sheet 280 according to the 2nd Example of the 2nd Embodiment in FIG. 2M, and FIG. 2P is a schematic view of an elastic portion 284 according to the 2nd Example of the 2nd Embodiment in FIG. 2M. In FIG. 2M to FIG. 2P, the resilience wiring sheet 280 according to the 2nd Example of the 2nd Embodiment is similar to the resilience wiring sheet 260 according to the 1st Example of the 2nd Embodiment, the difference is that the resilience wiring sheet 280 includes a movable end 281, two fixed ends 282, a connecting portion 283 and two elastic portions 284. The two elastic portions 284 respectively connect the two fixed ends 282 and two ends of the connecting portion 283, wherein each of the two elastic portions 284 includes at least two meandering branches 286. The at least two meandering branches 286 extend in a direction towards one of the two fixed ends 282, and the at least two meandering branches 286 overlap each other in a specific direction in view.

The structures, positions and connection relationships of the other elements according to the 2nd Example of the 2nd Embodiment are the same as or similar to the elements according to the 1st Example of the 2nd Embodiment, and will not describe again herein.

### 3rd Embodiment

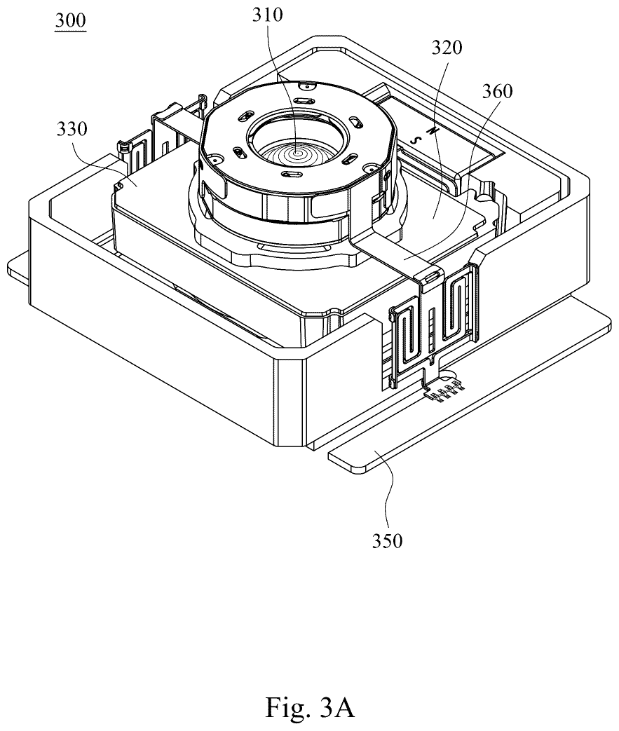

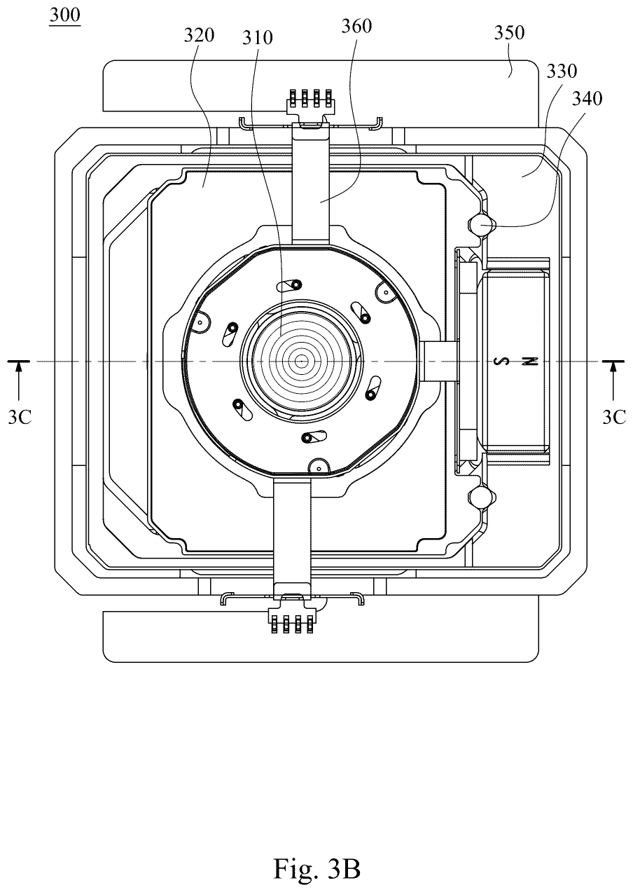

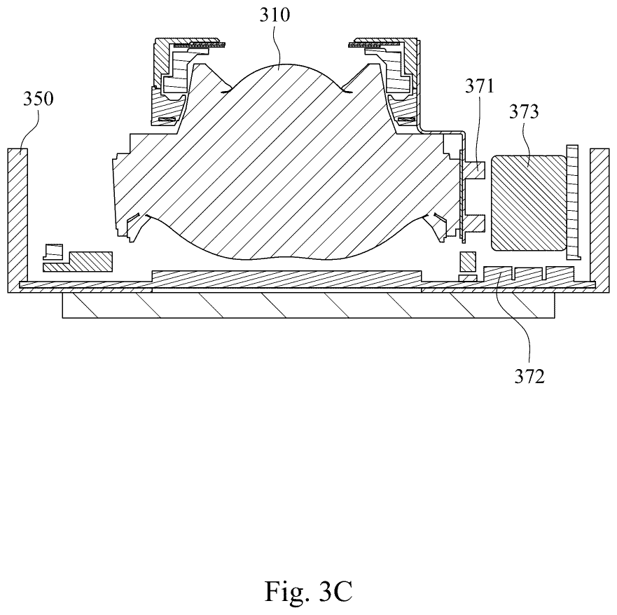

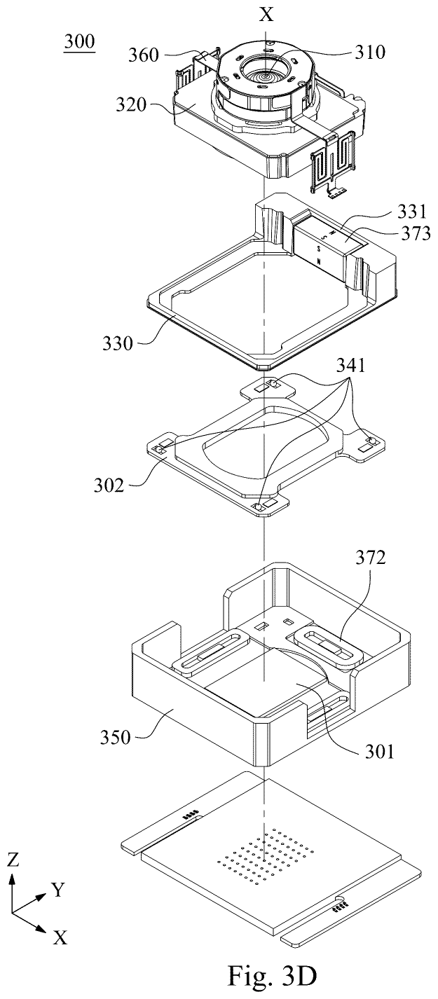

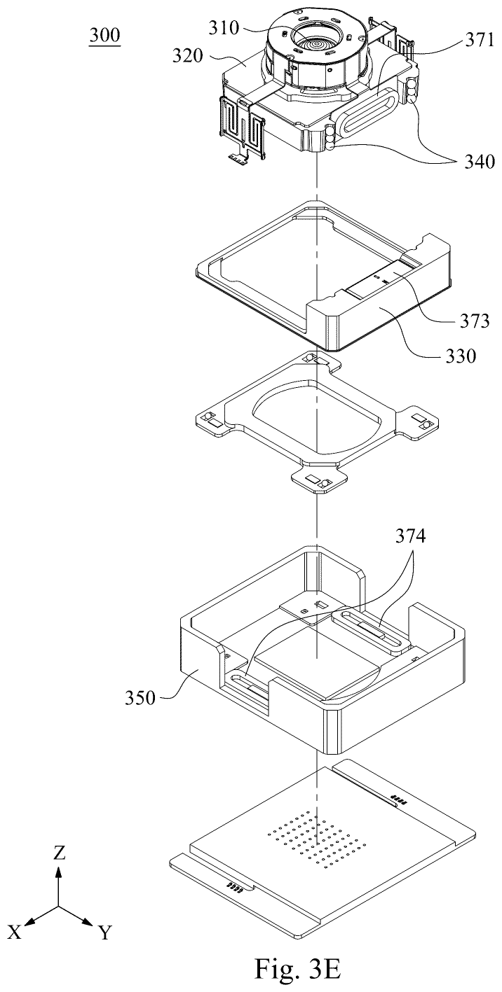

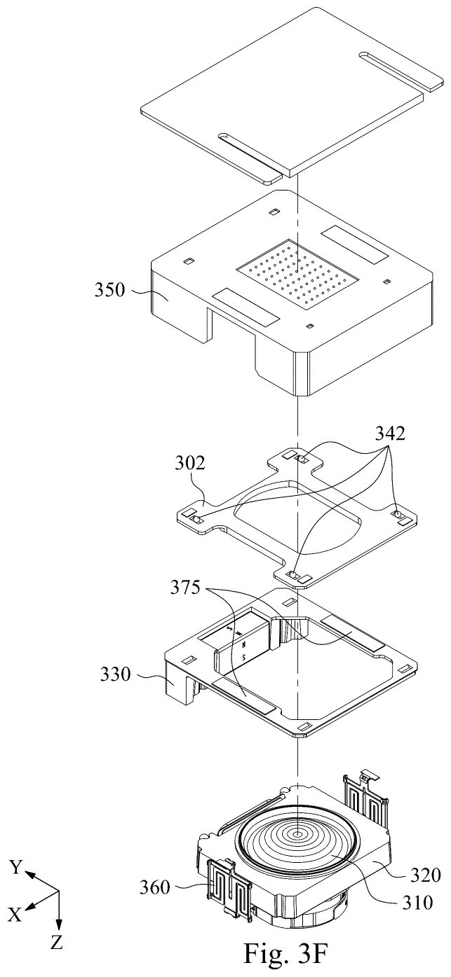

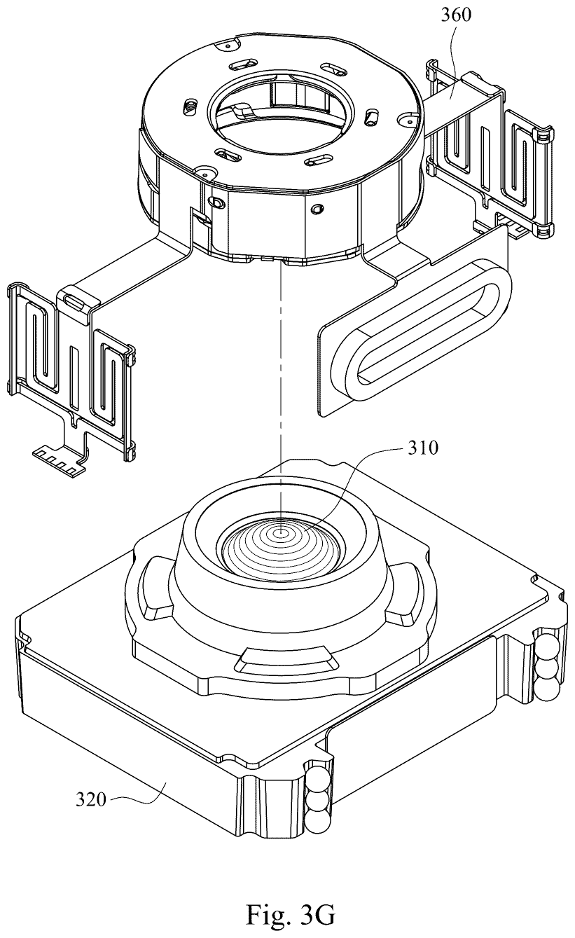

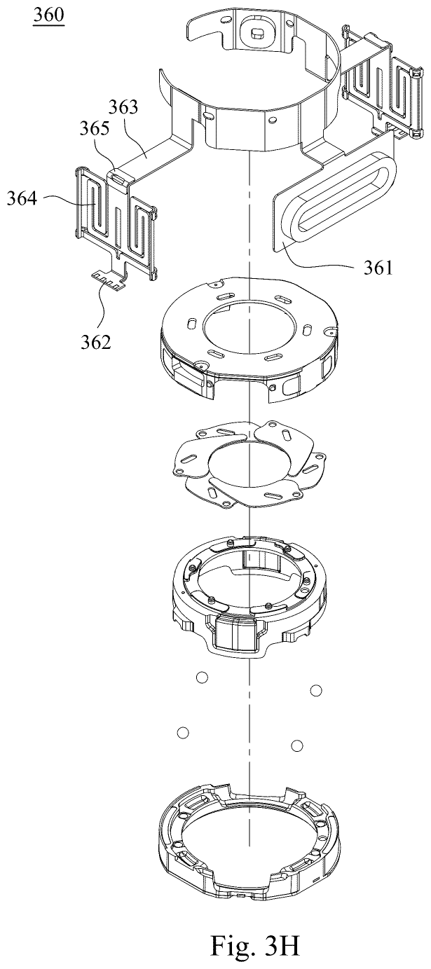

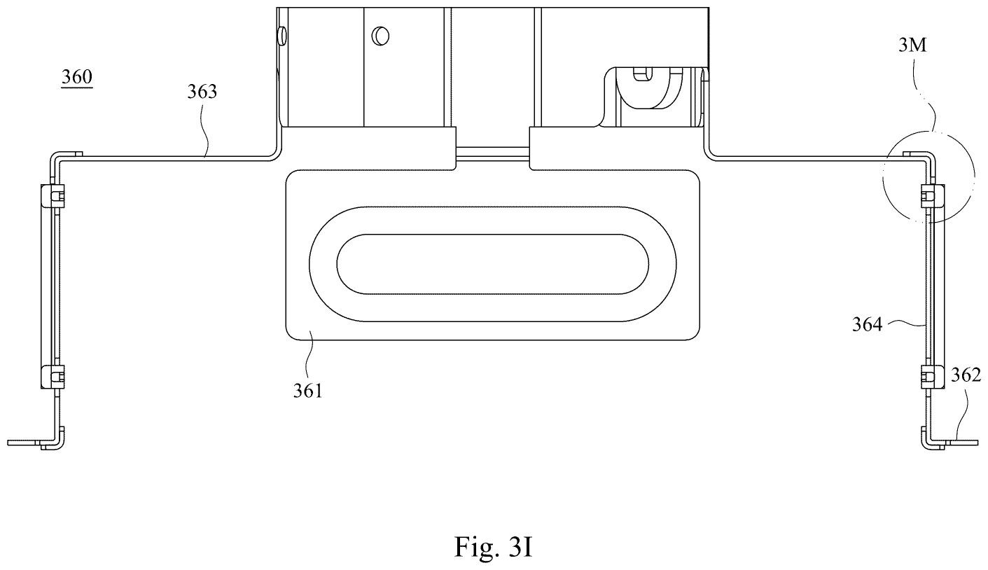

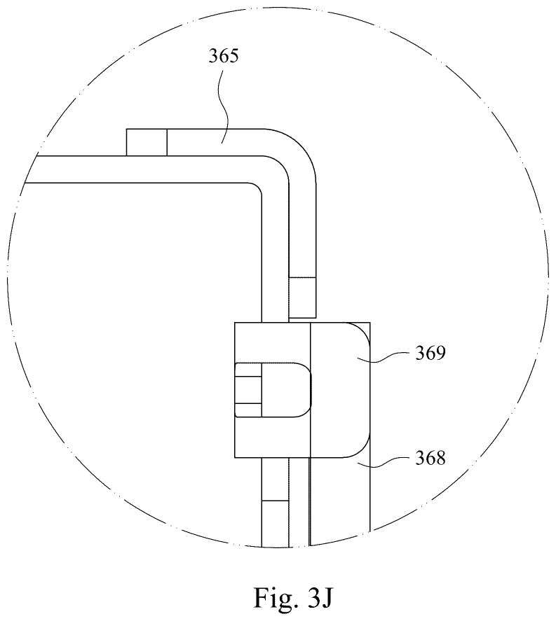

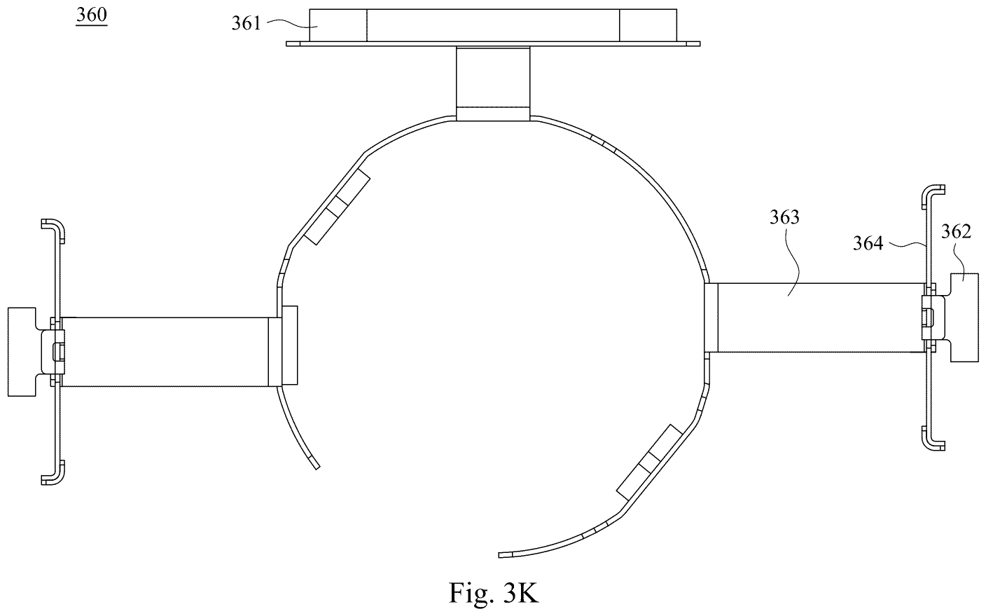

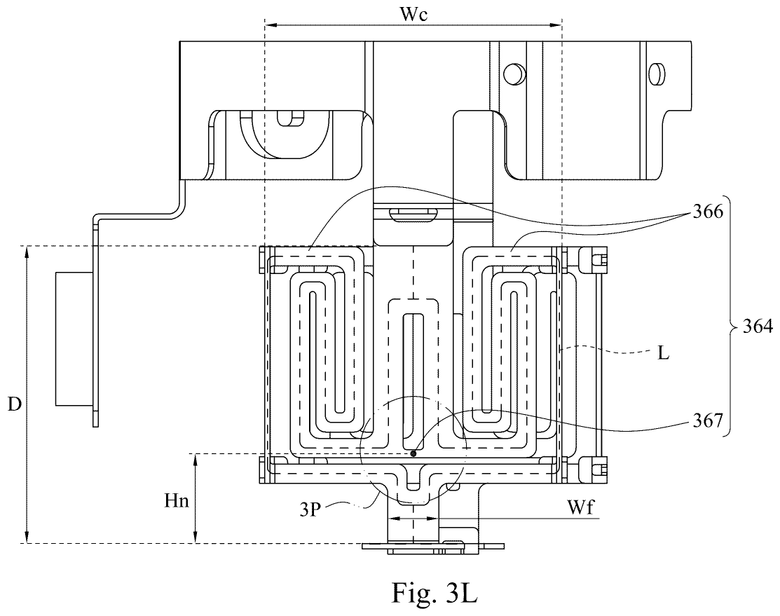

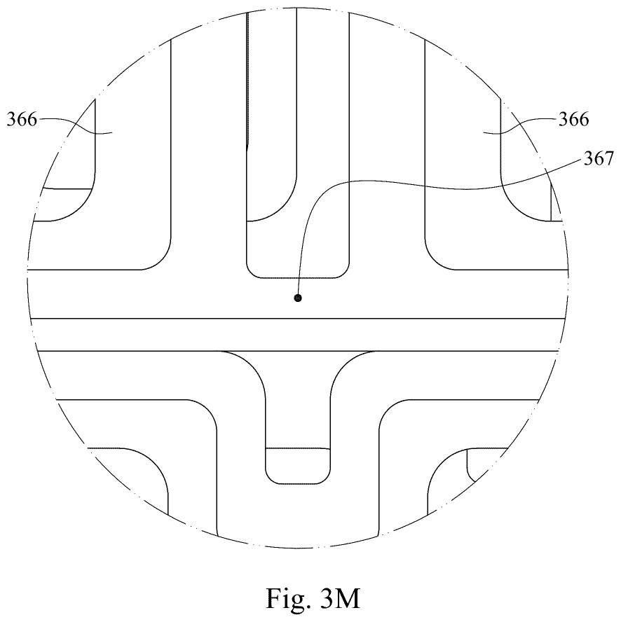

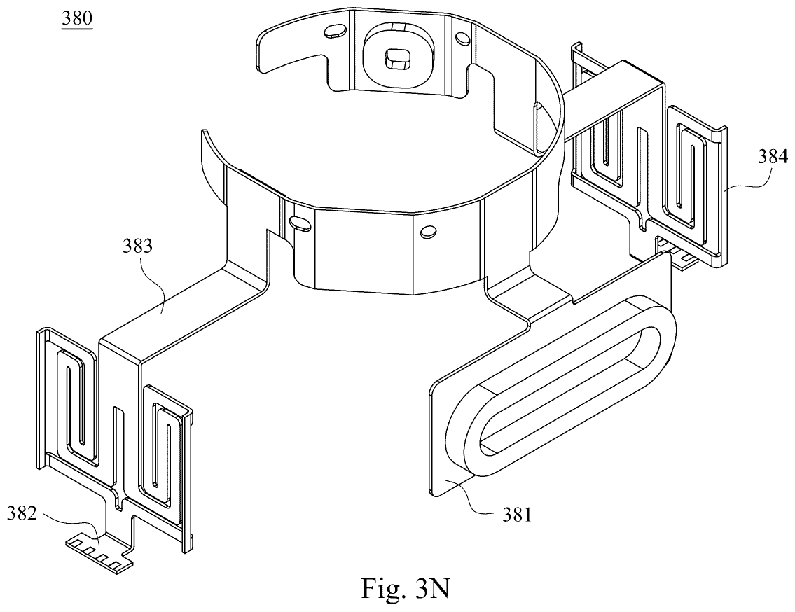

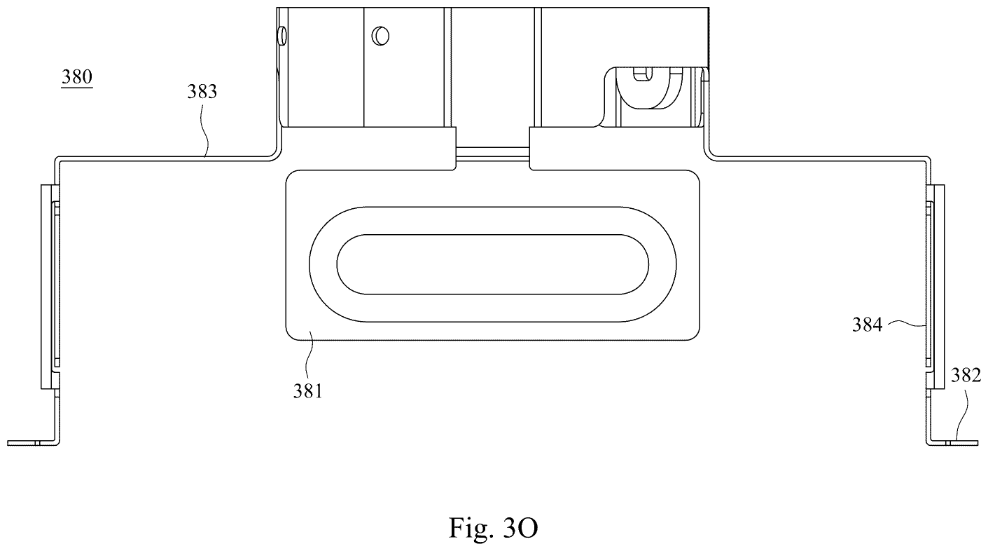

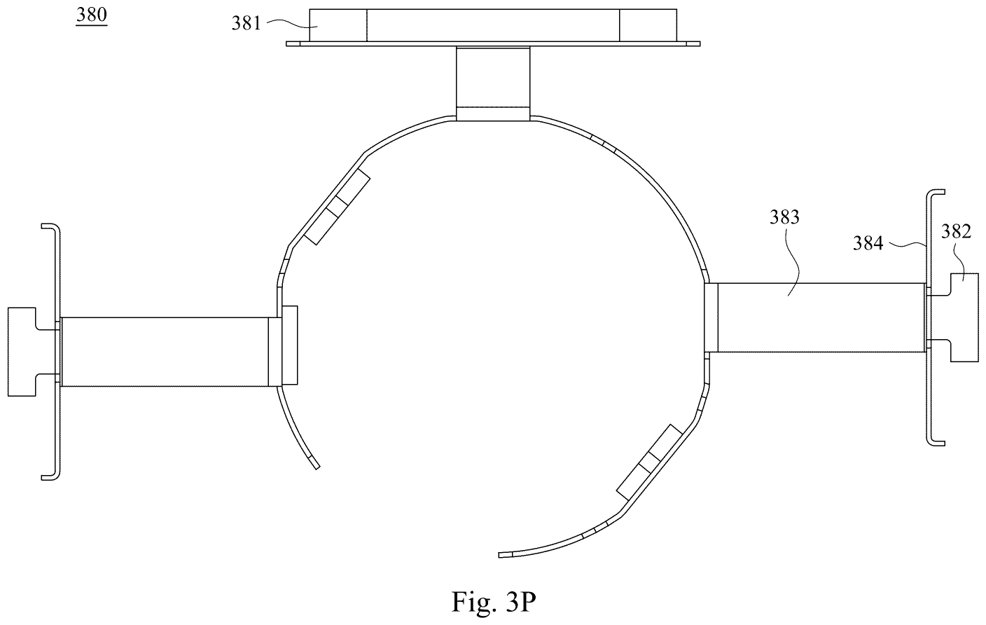

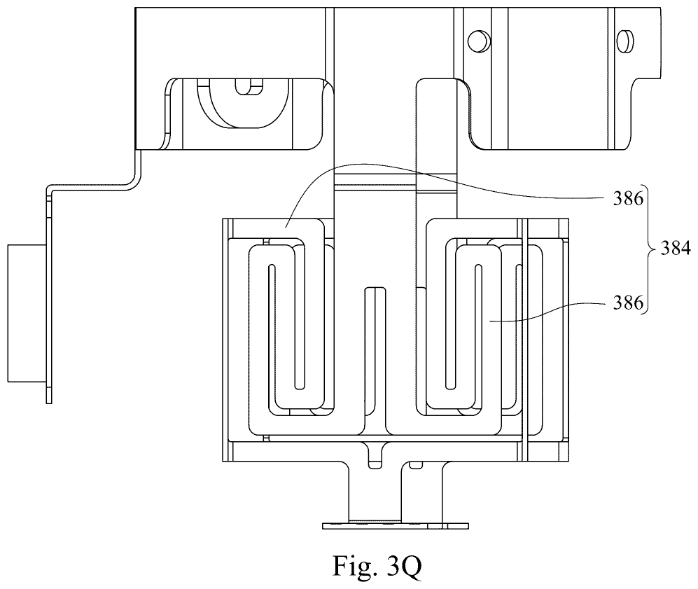

FIG. 3A is a three-dimensional view of a camera module 300 according to the 1st Example of the 3rd Embodiment of the present disclosure, FIG. 3B is a top view of the camera module 300 according to the 1st Example of the 3rd Embodiment in FIG. 3A, and FIG. 3D is an exploded view of the camera module 300 according to the 1st Example of the 3rd Embodiment in FIG. 3A. In FIG. 3A, FIG. 3B and FIG. 3D, the camera module 300 includes an imaging lens driving module (its reference numeral is omitted) and an image sensor 301, and the image sensor 301 corresponds to an image surface (its reference numeral is omitted) of the imaging lens assembly 310 of the imaging lens driving module. The imaging lens driving module includes the imaging lens assembly 310, a lens carrier 320, a frame element 330, a ball set 340, a wiring substrate 350, a resilience wiring sheet 360 and a driving unit (its reference numeral is omitted). The imaging lens assembly 310 has an optical axis X, the lens carrier 320 is configured to install the imaging lens assembly 310, the frame element 330 is disposed corresponding to the lens carrier 320, and the wiring substrate 350 is disposed on the image side of the imaging lens assembly 310.

Specifically, the wiring substrate 350 can be a printed circuit board, a flexible printed circuitboard, a rigid-flex board or a ceramic substrate, but not limited thereto.

FIG. 3E is another exploded view of the camera module 300 according to the 1st Example of the 3rd Embodiment in FIG. 3A, FIG. 3F is another exploded view of the camera module 300 according to the 1st Example of the 3rd Embodiment in FIG. 3A, FIG. 3G is a partial exploded view of the camera module 300 according to the 1st Example of the 3rd Embodiment in FIG. 3E, and FIG. 3H is a partial exploded view of the camera module 300 according to the 1st Example of the 3rd Embodiment in FIG. 3G. In FIG. 3D to FIG. 3H, the ball set 340 is physically contacted with the lens carrier 320 and the frame element 330. In detail, the imaging lens driving module of the camera module 300 can further include a base (its reference numeral is omitted), a movable plate 302, a first ball set 341 and a second ball set 342. The base is disposed corresponding to the frame element 330, and the base is coupled and fixed with the wiring substrate 350 without a movement relative to the wiring substrate 350. The movable plate 302 is disposed between the frame element 330 and the base. Moreover, the first ball set 341 is disposed between the frame element 330 and the movable plate 302, and the first ball set 341 provides a translational freedom for the frame element 330 moving in a direction perpendicular to the optical axis X and relative to the movable plate 302. The second ball set 342 is disposed between the movable plate 302 and the base, and the second ball set 342 provides another translational freedom for the movable plate 302 moving in a direction perpendicular to the optical axis X and relative to the base. Specifically, part of the wiring substrate 350 is integrally formed with the base.

FIG. 3I is a side view of the resilience wiring sheet 360 according to the 1st Example of the 3rd Embodiment in FIG. 3A, FIG. 3J is a partial enlarged view of the resilience wiring sheet 360 according to the 1st Example of the 3rd Embodiment in FIG. 3I, FIG. 3K is a top view of the resilience wiring sheet 360 according to the 1st Example of the 3rd Embodiment in FIG. 3A, FIG. 3L is a parameter schematic view of the resilience wiring sheet 360 according to the 1st Example of the 3rd Embodiment in FIG. 3A, and FIG. 3M is a partial enlarged view of the resilience wiring sheet 360 according to the 1st Example of the 3rd Embodiment in FIG. 3L. In FIG. 3A, FIG. 3B, FIG. 3E, FIG. 3G to FIG. 3M, the resilience wiring sheet 360 is configured to connect the lens carrier 320 and the wiring substrate 350, and the resilience wiring sheet 360 includes a movable end 361, two fixed ends 362, a connecting portion 363, two elastic portions 364 and a principal constraint component 365. The movable end 361 is coupled and fixed with the lens carrier 320 without a movement relative to the lens carrier 320, the two fixed ends 362 are coupled and fixed with the wiring substrate 350 without a movement relative to the wiring substrate 350, and the connecting portion 363 is connected to the movable end 361. Further, the principal constraint component 365 is coupled with the connecting portion 363 and the two elastic portions 364 so that a first angle is formed between the connecting portion 363 and the two elastic portions 364. Furthermore, the resilience wiring sheet 360 can include polyimide.

In detail, the connecting portion 363 of the resilience wiring sheet 360 can be in a ring shape, and can surround the imaging lens assembly 310, but not limited thereto. Specifically, the resilience wiring sheet 360 can be in a thin sheet shape, but not limited thereto. The movable end 361 can be where the resilience wiring sheet 360 and the lens carrier 320 are adhered to each other, but not limited thereto. The principal constraint component 365 can be an iron sheet with a bending angle to limit the bending degree of the resilience wiring sheet 360, but not limited thereto. The two fixed ends 362 can be where the resilience wiring sheet 360 and the wiring substrate 350 are welded to each other, but not limited thereto.

In FIG. 3I to FIG. 3M, the two elastic portions 364 respectively connect the two fixed ends 362 and two ends of the connecting portion 363, the two elastic portions 364 extend in a direction parallel to the optical axis X, and each of the two elastic portions 364 includes at least two meandering branches 366 and a node 367. The at least two meandering branches 366 of each of the two elastic portions 364 extend in a direction towards one of the two fixed ends 362, the at least two meandering branches 366 overlap each other in a specific direction in view, and the at least two meandering branches 366 extend in the direction towards one of the two fixed ends 362 and converge at the node 367. Specifically, the at least two meandering branches 366 are in a wiggling curve shape, the so-called wiggling curve shape can be a paper clip shape, a crab claw shape, etc., and the specific direction can be a direction perpendicular to the optical axis X or a direction perpendicular to the resilience wiring sheet 360, but not limited thereto. Furthermore, the shape design of each of the elastic portions 364 is wide at the top and narrow at the bottom so that the ability to adsorb the dragging force of the resilience wiring sheet 360 can be improved.

Moreover, each of the two elastic portions 364 can further include a reinforcing portion 368 and an auxiliary constraint component 369. The reinforcing portion 368 is connected to at least one of the at least two meandering branches 366 of each of the two elastic portions 364, and the auxiliary constraint component 369 is coupled with the reinforcing portion 368 and the at least one of the at least two meandering branches 366, so that a second angle is formed between the reinforcing portion 368 and the at least one of the at least two meandering branches 366. Specifically, the reinforcing portion 368 can be a side elevation surface extending from the meandering branches 366 with a bending angle, but not limited thereto.

FIG. 3C is a cross-sectional view of the camera module 300 along a cross line 3C-3C according to the 1st Example of the 3rd Embodiment in FIG. 3B. In FIG. 3B, FIG. 3C, FIG. 3D and FIG. 3F, the driving unit is configured to drive the lens carrier 320 to move relative to the wiring substrate 350 in a direction parallel to the optical axis X or in a direction perpendicular to the optical axis X, and the driving unit includes a first coil 371, a second coil 372 and a first magnetic element 373. The first coil 371 is disposed at the movable end 361 of the resilience wiring sheet 360, the second coil 372 is disposed on a surface of the wiring substrate 350, the first magnetic element 373 is disposed on an assembling portion 331 of the frame element 330, and the first magnetic element 373 faces and is disposed corresponding to both the first coil 371 and the second coil 372. Moreover, the driving unit can further include two third coils 374 and two second magnetic elements 375. The two third coils 374 are disposed on the other two surfaces of the wiring substrate 350, the two second magnetic elements 375 are disposed on the frame element 330, the two second magnetic elements 375 face the two third coils 374, and the two second magnetic elements 375 are disposed corresponding to the two third coils 374.

In detail, the driving unit can be configured to drive the lens carrier 320 to move relative to the frame element 330 in a direction parallel to the optical axis X, and the driving unit can be configured to drive the frame element 330 to move relative to the wiring substrate 350 in a direction perpendicular to the optical axis X.

Specifically, the Lorentz force generated by the electromagnetic interaction between the first coil 371 and the first magnetic element 373 pushes the lens carrier 320 to move relative to the frame element 330 in a direction parallel to the optical axis X. The Lorentz force generated by the electromagnetic interaction between the second coil 372 and the first magnetic element 373 pushes the frame element 330 to move relative to the wiring substrate 350 in a direction perpendicular to the optical axis X. Furthermore, the Lorentz force generated by the electromagnetic interaction between the two third coils 374 and the two second magnetic elements 375 push the frame element 330 to move relative to the wiring substrate 350 in a direction perpendicular to the optical axis X.

In FIG. 3L, when a straight length of one of the two elastic portions 364 in a direction along the optical axis X is D, a total length of the at least two meandering branches 366 is L, a maximum width of one of the two elastic portions 364 closed to the connecting portion 363 is Wc, a minimum width of each of the at least two meandering branches 366 closed to one of the two fixed ends 362 is Wf, and a shortest distance between one of the two fixed ends 362 and the node 367 in a direction parallel to the optical axis X is Hn, the mentioned parameters satisfy the following conditions in Table 3.

TABLE 3

| | | | |
|---|---|---|---|
| D (mm) | 5.588 | Hn (mm) | 1.687 |
| L (mm) | 48.224 | L/D | 8.63 |
| Wc (mm) | 5.58 | Wc/Wf | 5.81 |
| Wf (mm) | 0.96 | Hn/D | 0.30 |

FIG. 3N is a three-dimensional view of a resilience wiring sheet 380 according to the 2nd Example of the 3rd Embodiment in FIG. 3A, FIG. 3O is a side view of the resilience wiring sheet 380 according to the 2nd Example of the 3rd Embodiment in FIG. 3N, FIG. 3P is a top view of the resilience wiring sheet 380 according to the 2nd Example of the 3rd Embodiment in FIG. 3N, and FIG. 3Q is a schematic view of an elastic portion 384 according to the 2nd Example of the 3rd Embodiment in FIG. 3N. In FIG. 3O to FIG. 3Q, the resilience wiring sheet 380 according to the 2nd Example of the 3rd Embodiment is similar to the resilience wiring sheet 360 according to the 1st Example of the 3rd Embodiment, the difference is that the resilience wiring sheet 380 includes a movable end 381, two fixed ends 382, a connecting portion 383 and two elastic portions 384. The two elastic portions 384 respectively connect the two fixed ends 382 and two ends of the connecting portion 383, wherein each of the two elastic portions 384 includes at least two meandering branches 386. The at least two meandering branches 386 extend in a direction towards one of the two fixed ends 382, and the at least two meandering branches 386 overlap each other in a specific direction in view.

The structures, positions and connection relationships of the other elements according to the 2nd Example of the 3rd Embodiment are the same as or similar to the elements according to the 1st Example of the 3rd Embodiment, and will not describe again herein.

### 4th Embodiment

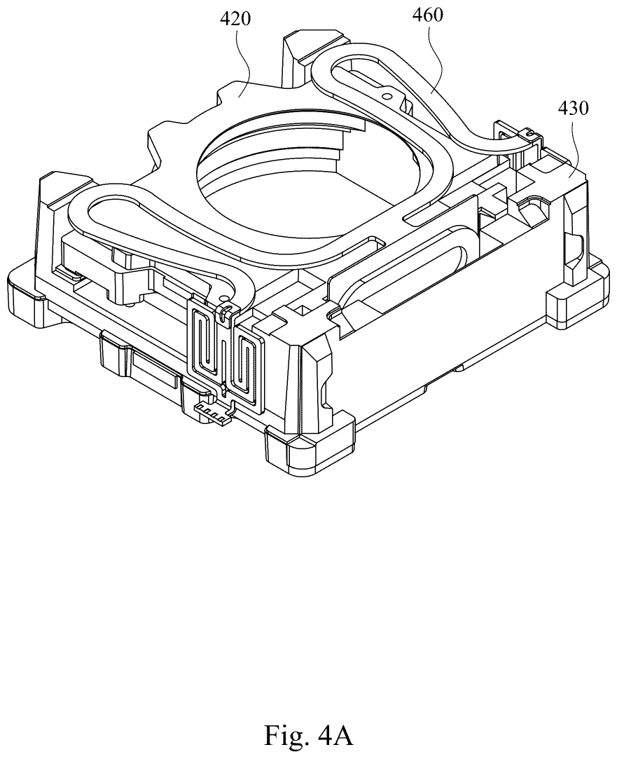

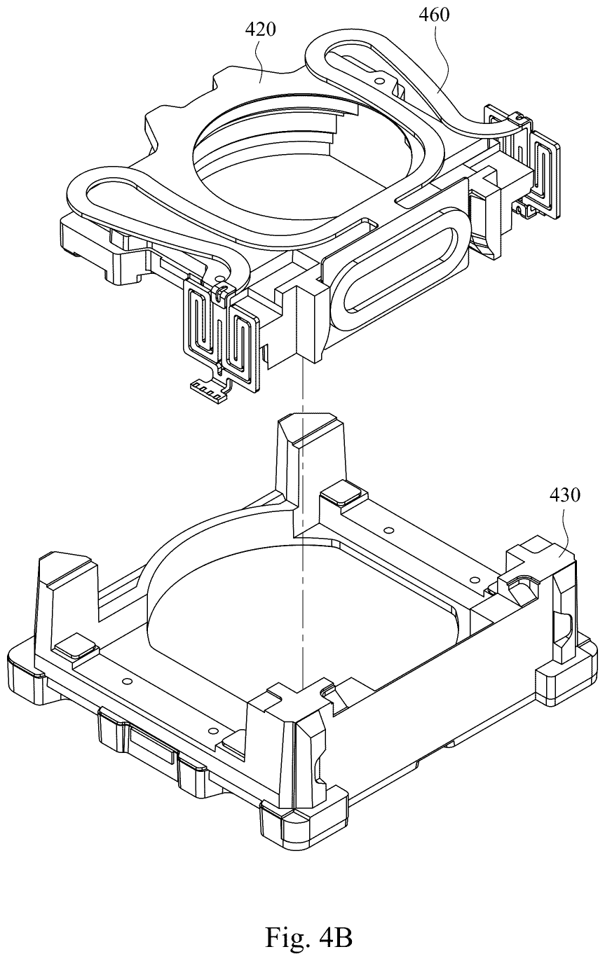

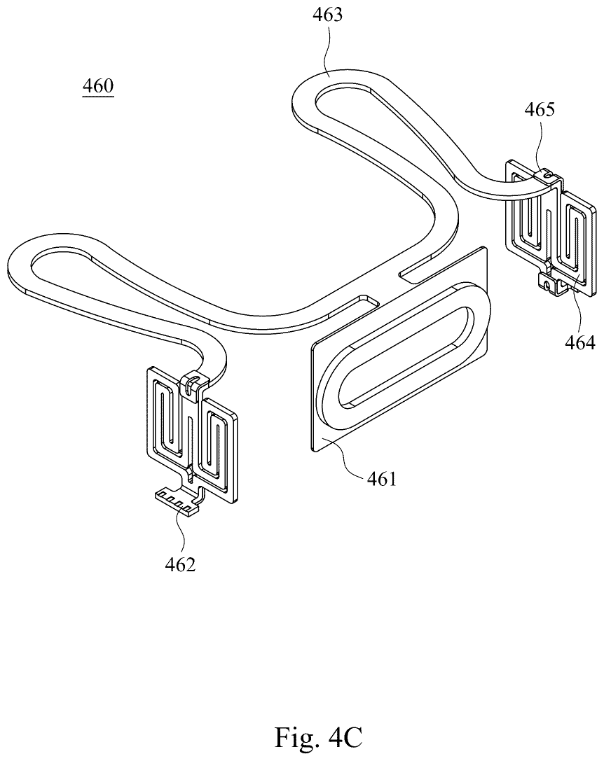

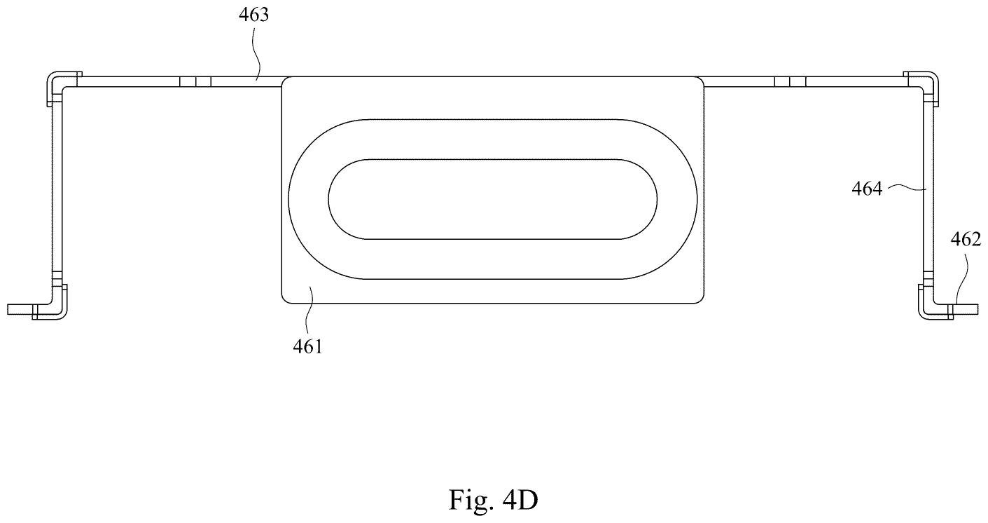

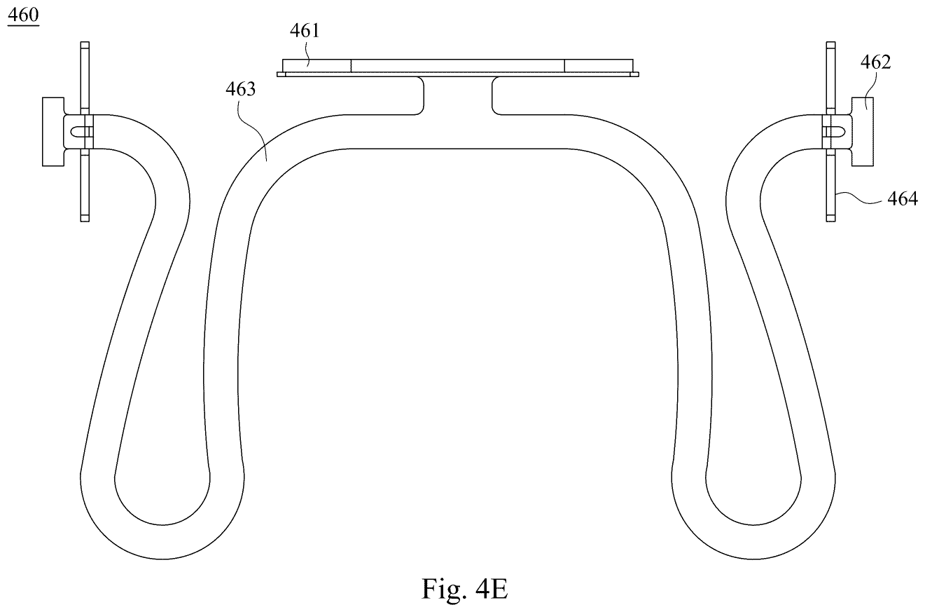

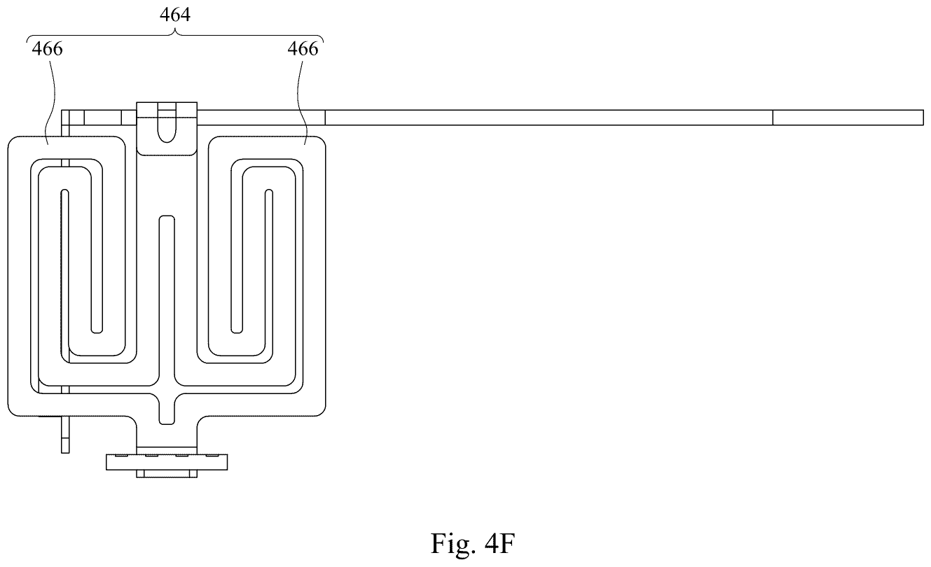

FIG. 4A is a three-dimensional view of a lens carrier 420, a frame element 430 and a resilience wiring sheet 460 according to the 1st Example of the 4th Embodiment of the present disclosure, FIG. 4B is an exploded view of the lens carrier 420, the frame element 430 and the resilience wiring sheet 460 according to the 1st Example of the 4th Embodiment in FIG. 4A, and FIG. 4C is a three-dimensional view of the resilience wiring sheet 460 according to the 1st Example of the 4th Embodiment in FIG. 4A. In FIG. 4A to FIG. 4C, the resilience wiring sheet 460 is configured to connect and to fix the lens carrier 420, wherein the resilience wiring sheet 460 can fix the lens carrier 420 in the frame element 430. In detail, the resilience wiring sheet 460 includes a movable end 461, two fixed ends 462, a connecting portion 463, two elastic portions 464 and a principal constraint component 465. The imaging lens driving module (not shown) according to the 1st Example of the 4th Embodiment is the same as or similar to the imaging lens driving module according to the 1st Example of the 2nd Embodiment, the difference is that the connecting portion 463 of the resilience wiring sheet 460 according to the 1st Example of the 4th Embodiment of the imaging lens driving module is in a wiggling curve shape. Therefore, the connecting portion 463 has a function similar to the two elastic portions 464.

FIG. 4D is a side view of the resilience wiring sheet 460 according to the 1st Example of the 4th Embodiment in FIG. 4C, FIG. 4E is a top view of the resilience wiring sheet 460 according to the 1st Example of the 4th Embodiment in FIG. 4C, and FIG. 4F is a schematic view of the elastic portion 464 according to the 1st Example of the 4th Embodiment in FIG. 4C. In FIG. 4B to FIG. 4F, the movable end 461 is coupled and fixed with the lens carrier 420 without a movement relative to the lens carrier 420, and the connecting portion 463 is connected to the movable end 461. Further, the principal constraint component 465 is coupled with the connecting portion 463 and the two elastic portions 464 so that a first angle is formed between the connecting portion 463 and the two elastic portions 464. Furthermore, the resilience wiring sheet 460 can include polyimide. Specifically, the resilience wiring sheet 460 can be in a thin sheet shape, but not limited thereto. The movable end 461 can be where the resilience wiring sheet 460 and the lens carrier 420 are adhered to each other, but not limited thereto. The principal constraint component 465 can be an iron sheet with a bending angle to limit the bending degree of the resilience wiring sheet 460, but not limited thereto.

Moreover, the two elastic portions 464 respectively connect the two fixed ends 462 and two ends of the connecting portion 463, the two elastic portions 464 extend in a direction parallel to the optical axis X, and each of the two elastic portions 464 includes at least two meandering branches 466. The at least two meandering branches 466 of each of the two elastic portions 464 extend in a direction towards one of the two fixed ends 462, and the at least two meandering branches 466 overlap each other in a specific direction in view. Specifically, the at least two meandering branches 466 are in a wiggling curve shape, the so-called wiggling curve shape can be a paper clip shape, a crab claw shape, etc., and the specific direction can be a direction perpendicular to the optical axis X or a direction perpendicular to the resilience wiring sheet 460, but not limited thereto.

### 5th Embodiment

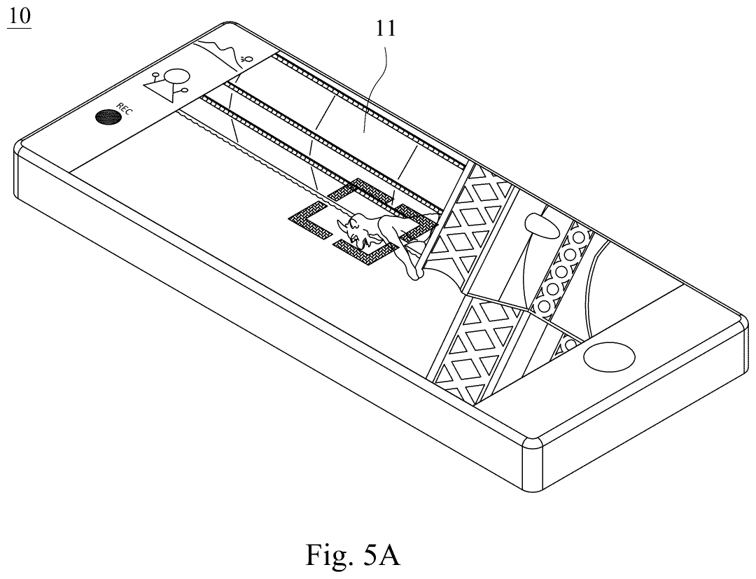

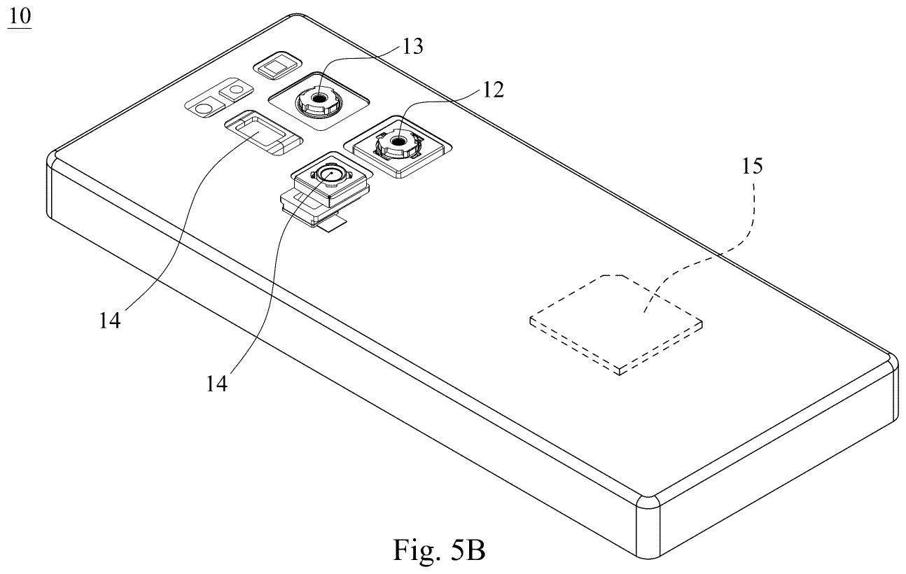

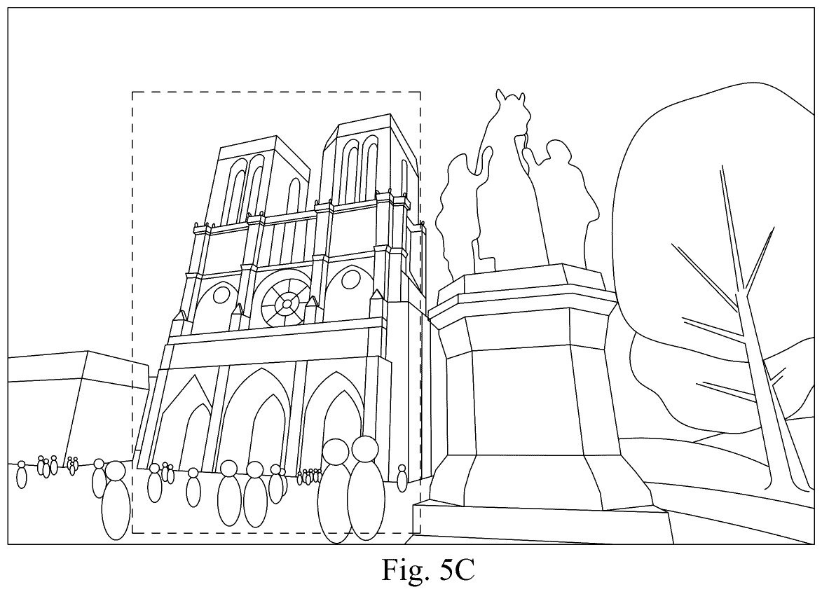

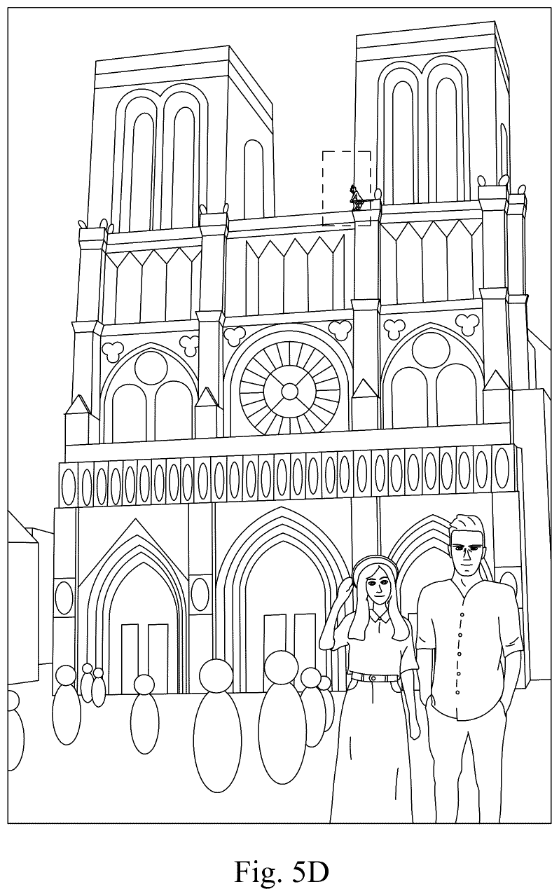

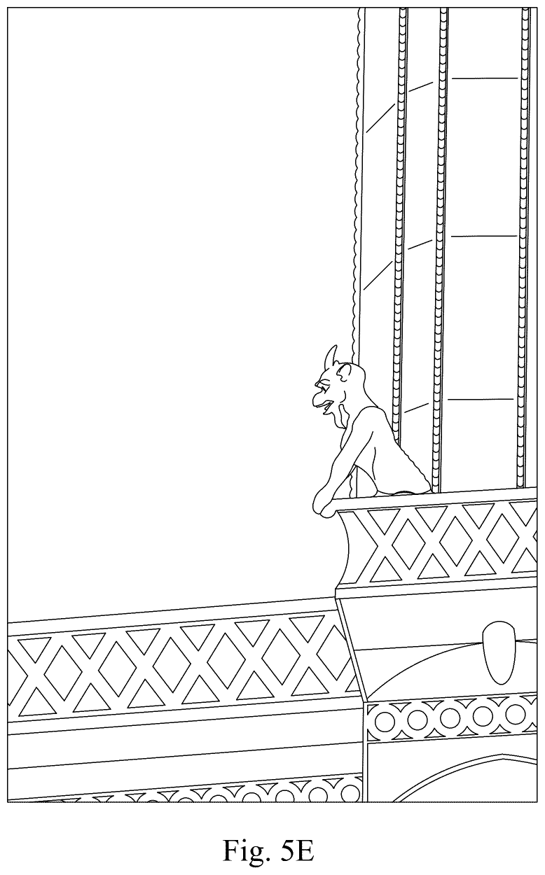

FIG. 5A is a schematic view of an electronic device 10 according to the 5th Embodiment of the present disclosure, and FIG. 5B is another schematic view of the electronic device 10 according to the 5th Embodiment in FIG. 5A. In FIG. 5A and FIG. 5B, the electronic device 10 is a smart phone, and the electronic device 10 includes camera modules and a user interface 11. Moreover, the camera modules are an ultra-wide angle camera module 12, a high resolution camera module 13 and a telephoto camera module 14, and the user interface 11 is a touch screen, but the present disclosure is not limited thereto. Particularly, the camera module can be the camera module according to any one of the aforementioned 1st Embodiment to the 4th Embodiment, but the present disclosure is not limited thereto.

A user enters a shooting mode via the user interface 11, wherein the user interface 11 is configured to display an image, and the shooting angle can be manually adjusted to switch to different camera modules. At this moment, the imaging light is gathered on an image sensor of the electronic device 10, and an electronic signal about an image is output to an image signal processor (ISP) 15.

In FIG. 5B, in order to meet a camera specification of the electronic device 10, the electronic device 10 can further include an optical anti-shake mechanism (not shown). Furthermore, the electronic device 10 can further include at least one focusing assisting module (not shown) and at least one sensing element (not shown). The focusing assisting module can be a flash module (not shown) for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera module of the electronic device 10 equipped with an auto-focusing mechanism and the optical anti-shake mechanism can be enhanced to achieve the superior image quality. Furthermore, the electronic device 10 according to the present disclosure can have a capturing function with multiple modes, such as taking optimized selfies, high dynamic range (HDR) under a low light condition, 4K resolution recording and so on. Furthermore, the user can visually see a captured image of the camera via the user interface 11 and manually operate the view finding range on the user interface 11 to achieve the autofocus function of what you see is what you get.

Moreover, the camera module, the optical anti-shake mechanism, the sensing element and the focusing assisting module can be disposed on a flexible printed circuit board (FPC) (not shown) and electrically connected to the image signal processor 15 and other related components, via a connector (not shown) to perform a capturing process. Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the camera module can also be controlled more flexibly via the touch screen of the electronic device. According to the 5th Embodiment, the electronic device 10 can include a plurality of sensing elements and a plurality of focusing assisting modules. The sensing elements and the focusing assisting modules are disposed on the flexible printed circuit board and at least one other flexible printed circuit board (not shown) and electrically connected to the image signal processor 15 and other related components, via corresponding connectors to perform the capturing process. In other embodiments (not shown), the sensing elements and the focusing assisting modules can also be disposed on the main board of the electronic device or carrier boards of other types according to requirements of the mechanical design and the circuit layout.

Furthermore, the electronic device 10 can further include, but not be limited to, a display, a control unit, a storage unit, a random access memory (RAM), a read-only memory (ROM), or the combination thereof.

FIG. 5C is a schematic view of an image captured via the electronic device 10 according to the 5th Embodiment in FIG. 5A. In FIG. 5C, the larger range of the image can be captured via the ultra-wide angle camera module 12, and the ultra-wide angle camera module 12 has the function of accommodating wider range of the scene.

FIG. 5D is a schematic view of another image captured via the electronic device 10 according to the 5th Embodiment in FIG. 5A. In FIG. 5D, the image of the certain range with the high resolution can be captured via the high resolution camera module 13, and the high resolution camera module 13 has the function of the high resolution and the low deformation.

FIG. 5E is a schematic view of another image captured via the electronic device 20 according to the 5th Embodiment in FIG. 5A. In FIG. 5E, the telephoto camera module 14 has the enlarging function of the high magnification, and the distant image can be captured and enlarged with high magnification via the telephoto camera module 14.

In FIG. 5C to FIG. 5E, the zooming function can be obtained via the electronic device 10, when the scene is captured via the camera modules with different focal lengths cooperated with the function of image processing.

### 6th Embodiment

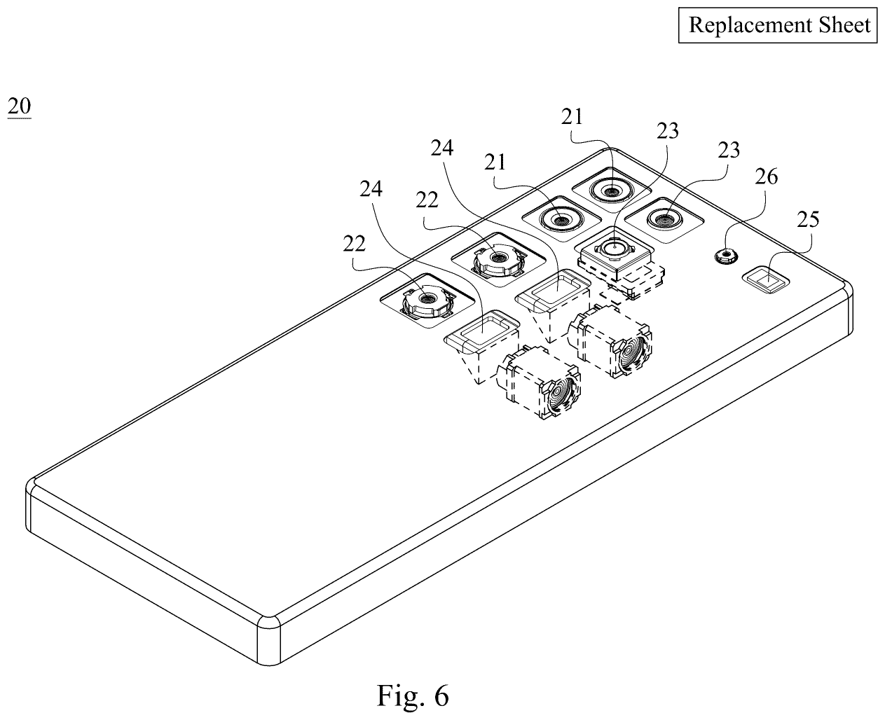

FIG. 6 is a schematic view of an electronic device 20 according to the 6th Embodiment of the present disclosure. In FIG. 6, the electronic device 20 is a smart phone, and the electronic device 20 includes camera modules. Moreover, the camera modules are ultra-wide angle camera modules 21, wide angle camera modules 22, telephoto camera modules 23, 24 and a Time-Of-Flight (TOF) module 26. The TOF module 26 can be another type of the camera module, and the disposition is not limited thereto. Particularly, the camera module can be the camera module according to any one of the aforementioned 1st Embodiment to the 4th Embodiment, but the present disclosure is not limited thereto.

Furthermore, the telephoto camera modules 24 are configured to fold the light, but the present disclosure is not limited thereto.

To meet a specification of the camera module of the electronic device 20, the electronic device 20 can further include an optical anti-shake mechanism (not shown). Furthermore, the electronic device 20 can further include at least one focusing assisting module (not shown) and at least one sensing element (not shown). The focusing assisting module can be a flash module 25 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera module of the electronic device 20 equipped with an auto-focusing mechanism and the optical anti-shake mechanism can be enhanced to achieve the superior image quality. Furthermore, the electronic device 20 according to the present disclosure can have a capturing function with multiple modes, such as taking optimized selfies, High Dynamic Range (HDR) under a low light condition, 4K Resolution recording and so on.

Moreover, all of other component structures and dispositions according to the 6th Embodiment are the same as the component structures and the dispositions according to the 5th Embodiment, and will not be described again herein.

### 7th Embodiment

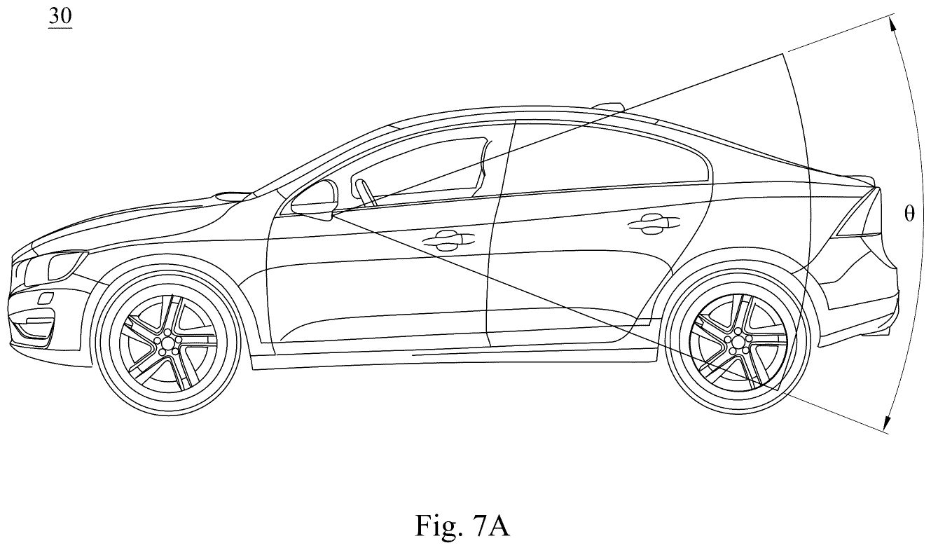

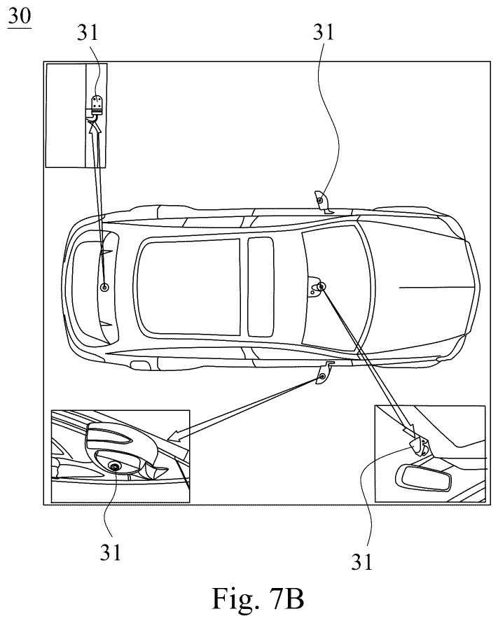

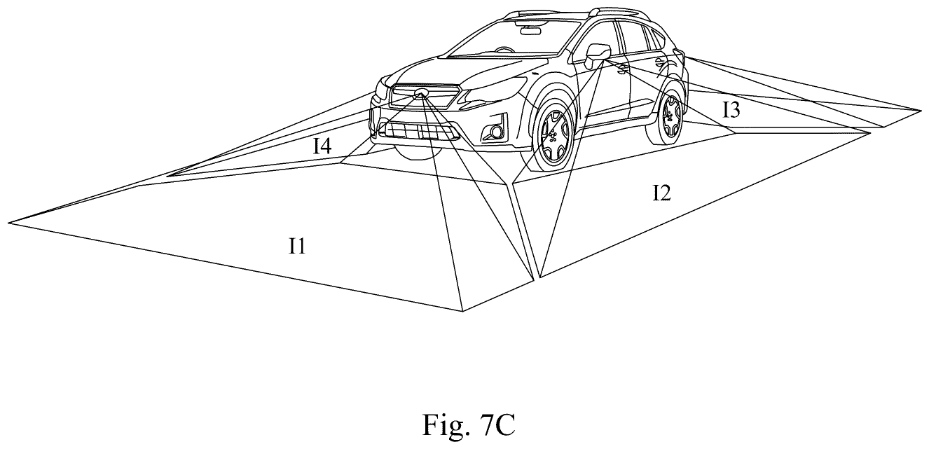

FIG. 7A is a schematic view of an electronic device applied to a vehicle 30 according to the 7th Embodiment of the present disclosure, FIG. 7B is another schematic view of the electronic device configured on the vehicle 30 according to the 7th Embodiment in FIG. 7A, and FIG. 7C is another schematic view of the electronic device configured on the vehicle 30 according to the 7th Embodiment in FIG. 7A. In FIG. 7A to FIG. 7C, the electronic device (its reference numeral is omitted) is applied to the vehicle 30, and the electronic device includes camera modules 31. In the 7th Embodiment, a number of the camera modules 31 is six, the camera modules 31 are vehicle camera modules, and the structures of the camera module can be the camera module according to any one of the aforementioned 1st Embodiment to the 4th Embodiment, but the present disclosure is not limited thereto.

In FIG. 7A to FIG. 7C, two of camera modules 31 are disposed below a left rearview mirror and a right rearview mirror, respectively, to capture the image information with a visual angle θ. Particularly, the visual angle θ can satisfy the following condition 40 degrees<θ<90 degrees. Therefore, the image information within a left lane and a right lane can be captured.

In FIG. 7A to FIG. 7C, another two of the camera modules 31 can be disposed in an inner space of the vehicle 30. Particularly, the another two of camera modules 31 are disposed near a rearview mirror and near a rear window in the vehicle 30 respectively. Moreover, the camera modules 31 can be disposed on the non-mirror surfaces of the left rearview mirror and the right rearview mirror of the vehicle 30, respectively, but the present disclosure is not limited thereto.

The other two of the camera modules 31 can be disposed at a front-end and a rear-end of the vehicle 30, respectively, wherein the camera modules 31 are disposed at a front-end and a rear-end of the vehicle 30, and below the left rearview mirror and the right rearview mirror. It is favorable to a driver to obtain the information of the outer space, such as external space information 11, 12, 13, 14, but the present disclosure is not limited thereto. Therefore, more visual angles can be provided to reduce the blind spot, so that the driving safety can be improved. Moreover, it is helpful to identify the traffic information out of the vehicle 30 via disposing the camera modules 31 around the vehicle 30, which is favorable for realizing a function of autopilot driving.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

1. An imaging lens driving module, comprising:
an imaging lens assembly having an optical axis;
a lens carrier configured to install the imaging lens assembly;
a frame element disposed corresponding to the lens carrier;
a ball set disposed between the lens carrier and the frame element, wherein the ball set is physically contacted with the lens carrier and the frame element;
a wiring substrate disposed on an image side of the imaging lens assembly;
a resilience wiring sheet configured to connect the lens carrier and the wiring substrate, and comprising:
a movable end coupled and fixed with the lens carrier without a movement relative to the lens carrier;
a fixed end coupled and fixed with the wiring substrate without a movement relative to the wiring substrate;
a connecting portion connected to the movable end;
an elastic portion connecting the fixed end and the connecting portion, wherein the elastic portion extends in a direction parallel to the optical axis, and comprises:
at least two meandering branches extending in a direction towards the fixed end, and overlapping each other in a specific direction in view; and
a node, wherein the at least two meandering branches extend in the direction towards the fixed end and converge at the node; and
a principal constraint component coupled with the connecting portion and the elastic portion so that a first angle is formed between the connecting portion and the elastic portion; and
a driving unit configured to drive the lens carrier to move relative to the wiring substrate in a direction parallel to the optical axis or in a direction perpendicular to the optical axis, and comprising:
a first coil disposed at the movable end of the resilience wiring sheet;
a second coil disposed on a surface of the wiring substrate; and
a first magnetic element disposed on an assembling portion of the frame element, wherein the first magnetic element faces and is disposed corresponding to both the first coil and the second coil;
wherein a straight length of the elastic portion in a direction along the optical axis is D, a total length of the at least two meandering branches is L, and the following conditions are satisfied:
$$D < L ; and$$
$$1.4 < L / D < 17.$$

2. The imaging lens driving module of claim 1, wherein the straight length of the elastic portion in a direction along the optical axis is D, the total length of the at least two meandering branches is L, and the following condition is satisfied:
$$2.1 < L / D < 14.3 .$$

3. The imaging lens driving module of claim 1, wherein the driving unit is configured to drive the lens carrier to move relative to the frame element in a direction parallel to the optical axis.

4. The imaging lens driving module of claim 1, wherein the driving unit is configured to drive the frame element to move relative to the wiring substrate in a direction perpendicular to the optical axis.

5. The imaging lens driving module of claim 1, wherein the at least two meandering branches are diverged away from each other after converging at the node, further extend towards the fixed end, and then approach each other.

6. The imaging lens driving module of claim 1, wherein the resilience wiring sheet comprises polyimide.

7. The imaging lens driving module of claim 1, wherein the elastic portion further comprises:
a reinforcing portion connected to at least one of the at least two meandering branches; and
an auxiliary constraint component coupled with the reinforcing portion and the at least one of the at least two meandering branches, so that a second angle is formed between the reinforcing portion and the at least one of the at least two meandering branches.

8. The imaging lens driving module of claim 1, wherein the driving unit further comprises:
a third coil disposed on the other surface of the wiring substrate; and
a second magnetic element disposed on the other assembling portion of the frame element, wherein the second magnetic element faces the third coil, and the second magnetic element is disposed corresponding to the third coil.

9. A camera module, comprising:
the imaging lens driving module of claim 1; and
an image sensor corresponding to an image surface of the imaging lens assembly of the imaging lens driving module.

10. An electronic device, comprising:
the camera module of claim 9.

11. An imaging lens driving module, comprising:
an imaging lens assembly having an optical axis;
a lens carrier configured to install the imaging lens assembly;
a frame element disposed corresponding to the lens carrier;
a ball set disposed between the lens carrier and the frame element, wherein the ball set is physically contacted with the lens carrier and the frame element;
a wiring substrate disposed on an image side of the imaging lens assembly;
a resilience wiring sheet configured to connect the lens carrier and the wiring substrate, and comprising:
a movable end coupled and fixed with the lens carrier without a movement relative to the lens carrier;
a fixed end coupled and fixed with the wiring substrate without a movement relative to the wiring substrate;
a connecting portion connected to the movable end; and
an elastic portion connecting the fixed end and the connecting portion, wherein the elastic portion extends in a direction parallel to the optical axis, and comprises:
at least two meandering branches extending in a direction towards the fixed end, and overlapping each other in a specific direction in view; and
a driving unit configured to drive the lens carrier to move relative to the wiring substrate in a direction parallel to the optical axis or in a direction perpendicular to the optical axis, and comprising:
a first coil disposed at the movable end of the resilience wiring sheet;
a second coil disposed on a surface of the wiring substrate; and
a first magnetic element disposed on an assembling portion of the frame element, wherein the first magnetic element faces and is disposed corresponding to both the first coil and the second coil;
wherein a maximum width of the elastic portion closed to the connecting portion is Wc, a minimum width of each of the at least two meandering branches closed to the fixed end is Wf, and the following conditions are satisfied:
$$Wf < Wc ; and$$
$$1.5 < Wc / Wf < 16.$$

12. The imaging lens driving module of claim 11, wherein the maximum width of the elastic portion closed to the connecting portion is Wc, the minimum width of each of the at least two meandering branches closed to the fixed end is Wf, and the following condition is satisfied:
$$1.9 < Wc / Wf < 12.7 .$$

13. The imaging lens driving module of claim 11, wherein a straight length of the elastic portion in a direction along the optical axis is D, a total length of the at least two meandering branches is L, and the following conditions are satisfied:
$$D < L ; and$$
$$2.1 < L / D < 14.3 .$$

14. The imaging lens driving module of claim 11, wherein the driving unit is configured to drive the lens carrier to move relative to the frame element in a direction parallel to the optical axis.

15. The imaging lens driving module of claim 11, wherein the driving unit is configured to drive the frame element to move relative to the wiring substrate in a direction perpendicular to the optical axis.

16. The imaging lens driving module of claim 11, wherein the resilience wiring sheet further comprises:
a principal constraint component coupled with the connecting portion and the elastic portion so that a first angle is formed between the connecting portion and the elastic portion.

17. The imaging lens driving module of claim 12, wherein the elastic portion of the resilience wiring sheet further comprises:
a node, wherein the at least two meandering branches extend in the direction towards the fixed end and converge at the node;
wherein the at least two meandering branches are diverged away from each other after converging at the node, further extend towards the fixed end, and then approach each other.

18. The imaging lens driving module of claim 11, wherein the resilience wiring sheet comprises polyimide.

19. The imaging lens driving module of claim 11, wherein the elastic portion further comprises:
a reinforcing portion connected to at least one of the at least two meandering branches; and
an auxiliary constraint component coupled with the reinforcing portion and the at least one of the at least two meandering branches, so that a second angle is formed between the reinforcing portion and the at least one of the at least two meandering branches.

20. The imaging lens driving module of claim 11, wherein the driving unit further comprises:
a third coil disposed on the other surface of the wiring substrate; and
a second magnetic element disposed on the other assembling portion of the frame element, wherein the second magnetic element faces the third coil, and the second magnetic element is disposed corresponding to the third coil.

21. An imaging lens driving module, comprising:
an imaging lens assembly having an optical axis;
a lens carrier configured to install the imaging lens assembly;
a frame element disposed corresponding to the lens carrier;
a ball set disposed between the lens carrier and the frame element, wherein the ball set is physically contacted with the lens carrier and the frame element;
a wiring substrate disposed on an image side of the imaging lens assembly;
a resilience wiring sheet configured to connect the lens carrier and the wiring substrate, and comprising:
a movable end coupled and fixed with the lens carrier without a movement relative to the lens carrier;
a fixed end coupled and fixed with the wiring substrate without a movement relative to the wiring substrate;
a connecting portion connected to the movable end; and
an elastic portion connecting the fixed end and the connecting portion, wherein the elastic portion extends in a direction parallel to the optical axis, and comprises:
at least two meandering branches extending in a direction towards the fixed end, and overlapping each other in a specific direction in view; and
a node, wherein the at least two meandering branches extend in the direction towards the fixed end and converge at the node; and
a driving unit configured to drive the lens carrier to move relative to the wiring substrate in a direction parallel to the optical axis, and comprising:
a first coil disposed at the movable end of the resilience wiring sheet; and
a first magnetic element disposed on an assembling portion of the frame element, wherein the first magnetic element faces and is disposed corresponding to the first coil;
wherein a shortest distance between the fixed end and the node in a direction parallel to the optical axis is Hn, a straight length of the elastic portion in a direction along the optical axis is D, and the following conditions are satisfied:
$$Hn < D ; and$$
$$0.1 \leq Hn / D \leq 0.7 .$$

22. The imaging lens driving module of claim 21, wherein the shortest distance between the fixed end and the node in a direction parallel to the optical axis is Hn, the straight length of the elastic portion in a direction along the optical axis is D, and the following condition is satisfied:
$$0.2 \leq Hn / D \leq 0.55 .$$

23. The imaging lens driving module of claim 21, wherein the driving unit is configured to drive the lens carrier to move relative to the frame element in a direction parallel to the optical axis.

24. The imaging lens driving module of claim 21, wherein the driving unit further comprises:
a second coil disposed on a surface of the wiring substrate;
wherein the first magnetic element faces and is disposed corresponding to both the first coil and the second coil.

25. The imaging lens driving module of claim 24, wherein the driving unit is configured to drive the frame element to move relative to the wiring substrate in a direction perpendicular to the optical axis.

26. The imaging lens driving module of claim 21, wherein the resilience wiring sheet further comprises:
a principal constraint component coupled with the connecting portion and the elastic portion so that a first angle is formed between the connecting portion and the elastic portion.

27. The imaging lens driving module of claim 21, wherein the at least two meandering branches are diverged away from each other after converging at the node, further extend towards the fixed end, and then approach each other.

28. The imaging lens driving module of claim 21, wherein the resilience wiring sheet comprises polyimide.

29. The imaging lens driving module of claim 21, wherein the elastic portion further comprises:
a reinforcing portion connected to at least one of the at least two meandering branches; and
an auxiliary constraint component coupled with the reinforcing portion and the at least one of the at least two meandering branches, so that a second angle is formed between the reinforcing portion and the at least one of the at least two meandering branches.

30. The imaging lens driving module of claim 24, wherein the driving unit further comprises:
a third coil disposed on the other surface of the wiring substrate; and
a second magnetic element disposed on the other assembling portion of the frame element, wherein the second magnetic element faces the third coil, and the second magnetic element is disposed corresponding to the third coil.
